(19) United States
(12) Patent Application Publication
(10) Pub. No.: US 2015/0237560 A1
(43) Pub. Date: Aug. 20, 2015

(54) WIRELESS COMMUNICATION TERMINAL, COMMUNICATION METHOD, PROGRAM, INFORMATION PROCESSING APPARATUS AND DISTRIBUTION SERVER

(71) Applicant: NEC Corporation, Tokyo (JP)

(72) Inventor: Yoshinori Saida, Tokyo (JP)

(21) Appl. No.: 14/426,132

(22) PCT Filed: Sep. 4, 2013
(86) PCT No.: PCT/JP2013/005229

§ 371 Date: Mar. 4, 2015

(30) Foreign Application Priority Data
Sep. 5, 2012 (JP) 2012-194845

(51) Int. Cl. H04W 36/36; H04W 48/16

(52) U.S. Cl. CPC H04W 36/365; H04W 48/16; H04W 48/18

(57) ABSTRACT

A wireless communication terminal, includes: a plurality of communication interfaces each of which corresponds to at least one of a plurality of wireless access schemes; a first unit for displaying information representing the plurality of wireless access schemes as a list in accordance with a priority order; and a second unit for communicating using a communication interface corresponding to a wireless access scheme selected from the list.

### CROSS-REFERENCE TO RELATED APPLICATIONS

This application is based upon and claims the benefit of priority of Japanese Patent Application No. 2012-194845, filed on Sep. 5, 2012, the disclosure of which is incorporated herein in its entirety by reference thereto. The present invention relates to a wireless communication terminal, a communication method, a program, an information processing apparatus and a distribution server, and relates to a wireless communication terminal, a communication method, a program, an information processing apparatus and a distribution server, whereby a wireless access scheme to be used in communication is selected.

### TECHNICAL FIELD

### Background Art

In recent years the increasing volume of data communication by terminals such as mobile telephones and the like is becoming a problem for communications operators. As a countermeasure to the increasing data communication volume, the communications operators are attempting, for example, to offload data communication that uses a cellular network to a WLAN (Wireless Local Area Network) such as in WiFi (Wireless Fidelity) or the like.

Patent Literature 1 discloses technology related to switching between a cellular network and a WLAN. A communication apparatus in Patent Literature 1 determines whether or not a WLAN is available. The communication apparatus connects to the WLAN in a case where the WLAN is available, and connects to a cellular network in a case where a WLAN is not available.

Patent Literature 2 discloses technology for selecting a communication system to be used in communication, from a plurality of communication systems. In Patent Literature 2, a communication terminal switches the communication system based on a priority list of the plurality of communication systems.

### CITATION LIST

### Patent Literature

### [PTL 1]

### Japanese Translation of PCT International Publication, Publication No. 2006-516376

### [PTL 2]

Japanese Patent Kokai Publication No. JP2012-23506A

### SUMMARY OF INVENTION

### Technical Problem

The entire disclosures of the above cited Patent Literatures are incorporated herein by reference thereto. The following analyses are given by the present invention. A problem of the technology disclosed by Patent Literature 1 is that technology is not disclosed by which a user of a terminal intervenes in switching between a cellular network and a WLAN.

By forcibly switching to the WLAN in a case where the WLAN is available, it is possible to offload data communication to the WLAN. Therefore, the technology disclosed in Patent Literature 1 may be very useful for a communications operator. However, the terminal user does not necessarily desire data communication by the WLAN. The terminal user himself may wish to select a network to be used in communication.

Since the technology disclosed in Patent Literature 2 is technology in which the communication terminal forcibly switches a communication system based on a priority list, it is difficult for a user of the terminal to intervene in selection of the communication system. Accordingly, even with the technology disclosed in Patent Literature 2 a solution to the problem described above is difficult.

Therefore, there is a need in the art to enable a user to select a network to be used in communication, and to enable recommending to the user that a network be switched. It is an object of the present invention to provide a wireless communication terminal, a communication method, a program, an information processing apparatus and a distribution server that contribute to the need.

### Solution to Problem

According to a first aspect of the present invention, there is provided a wireless communication terminal, comprising: a plurality of communication interfaces each of which corresponds to at least one of a plurality of wireless access schemes; first means for displaying information representing the plurality of wireless access schemes as a list in accordance with a priority order; and second means for communicating using a communication interface corresponding to a wireless access scheme selected from the list.

According to a second aspect of the present invention, there is provided a communication method, comprising: using a wireless communication terminal that comprises a plurality of communication interfaces corresponding to at least one of a plurality of wireless access schemes; displaying information representing the plurality of wireless access schemes as a list in accordance with a priority order; and communicating using a communication interface corresponding to a wireless access scheme selected from the list.

According to a third aspect of the present invention, there is provided a program, causing a wireless communication terminal comprising a plurality of communication interfaces corresponding to at least one of a plurality of wireless access schemes to execute: displaying information representing the plurality of wireless access schemes as a list in accordance with a priority order; and communicating using a communication interface corresponding to a wireless access scheme selected from the list.

According to a fourth aspect of the present invention, there is provided an information processing apparatus, comprising: first means for enabling communication with a wireless communication terminal comprising a plurality of communication interfaces corresponding to at least one of a plurality of wireless access schemes; and second means for determining priority order of the plurality of wireless access schemes and transmitting a list in accordance with the priority order to the wireless communication terminal.

According to a fifth aspect of the present invention, there is provided a distribution server, comprising: means for distributing a program to a wireless communication terminal comprising a plurality of communication interfaces corresponding to at least one of a plurality of wireless access schemes. The program causes the wireless communication terminal to execute: displaying information representing the plurality of wireless access schemes as a list in accordance with a priority order; and communicating using a communication interface corresponding to a wireless access scheme selected from the list. The above program may be recorded on a non-transitory computer-readable recording medium and provided as a program product.

### Advantageous Effects of Invention

A wireless communication terminal, a communication method, a program, an information processing apparatus and a distribution server according to the present invention enable a user to select a network to be used in communication, in addition to enabling recommending to the user that the network be switched.

### BRIEF DESCRIPTION OF DRAWINGS

FIG. 1 is a diagram showing an example of a system configuration of a first exemplary embodiment.

FIG. 2 is a diagram showing a configuration example of a wireless communication terminal of the first exemplary embodiment.

FIG. 3 is a diagram showing an example of a list 100 of wireless access schemes displayed by the wireless communication terminal of the first exemplary embodiment.

FIG. 4 is a sequence diagram showing an operational example of the first exemplary embodiment.

FIG. 5 is a diagram showing an operational example of a second exemplary embodiment.

FIG. 6 is a diagram showing an operational example of the second exemplary embodiment.

FIG. 7 is a diagram showing an operational example of the second exemplary embodiment.

FIG. 8 is a diagram showing an operational example of the second exemplary embodiment.

FIG. 9 is a diagram showing an operational example of the second exemplary embodiment.

FIG. 10 is a diagram showing an operational example of the second exemplary embodiment.

FIG. 11 is a diagram showing an operational example of the second exemplary embodiment.

FIG. 12 is a diagram showing an example of a user interface of a third exemplary embodiment.

FIG. 13 is a diagram showing an example of a user interface of the third exemplary embodiment.

FIG. 14 is a diagram showing an example of a user interface of the third exemplary embodiment.

FIG. 15 is a diagram showing an example of a user interface of the third exemplary embodiment.

FIG. 16 is a diagram showing an example of a user interface of the third exemplary embodiment.

FIG. 17 is a diagram showing an example of a user interface of the third exemplary embodiment.

FIG. 18 is a diagram showing an example of a user interface of the third exemplary embodiment.

FIG. 19 is a diagram showing an example of a user interface of the third exemplary embodiment.

FIG. 20 is a diagram showing a configuration example of a fourth exemplary embodiment.

FIG. 21 is a diagram showing an example of a system configuration of a fifth exemplary embodiment.

FIG. 22 is a diagram showing a configuration example of a control server of the fifth exemplary embodiment.

FIG. 23 is a diagram showing a configuration example of a database of the fifth exemplary embodiment.

FIG. 24 is a diagram showing a configuration example of a database of the fifth exemplary embodiment.

FIG. 25 is a diagram showing a configuration example of a control server of the fifth exemplary embodiment.

FIG. 26 is a diagram showing an example of technology related to a sixth exemplary embodiment.

FIG. 27 is a diagram showing an example of technology related to the sixth exemplary embodiment.

FIG. 28 is a diagram showing an example of a system configuration of the sixth exemplary embodiment.

FIG. 29 is a diagram showing a configuration example of a wireless communication terminal of the sixth exemplary embodiment.

FIG. 30 is a diagram showing a configuration example of a control server of the sixth exemplary embodiment.

FIG. 31 is a diagram showing an operational example of the sixth exemplary embodiment.

FIG. 32 is a diagram showing an operational example of the sixth exemplary embodiment.

FIG. 33 is a diagram showing a configuration example of a virtual switch of the sixth exemplary embodiment.

FIG. 34 is a sequence chart showing an operational example of the sixth exemplary embodiment.

FIG. 35 is a diagram showing an example of a system configuration of a seventh exemplary embodiment.

FIG. 36 is a diagram showing a configuration example of the seventh exemplary embodiment.

FIG. 37 is a diagram showing an operational example of the seventh exemplary embodiment.

FIG. 38 is a diagram showing a configuration example of an eighth exemplary embodiment.

FIG. 39 is a diagram showing a configuration example of a ninth exemplary embodiment.

### DESCRIPTION OF EMBODIMENTS

### First Exemplary Embodiment

In a first exemplary embodiment of the present invention, a wireless communication terminal 1 has a function to display information representing a plurality of RATs (Radio Access Technology) as a list 100 in accordance with a priority order. The wireless communication terminal 1 enables recommending to a user that a RAT be switched, according to the list 100 according to the priority order. The user can refer to the priority order to select a RAT in accordance with his own preference.

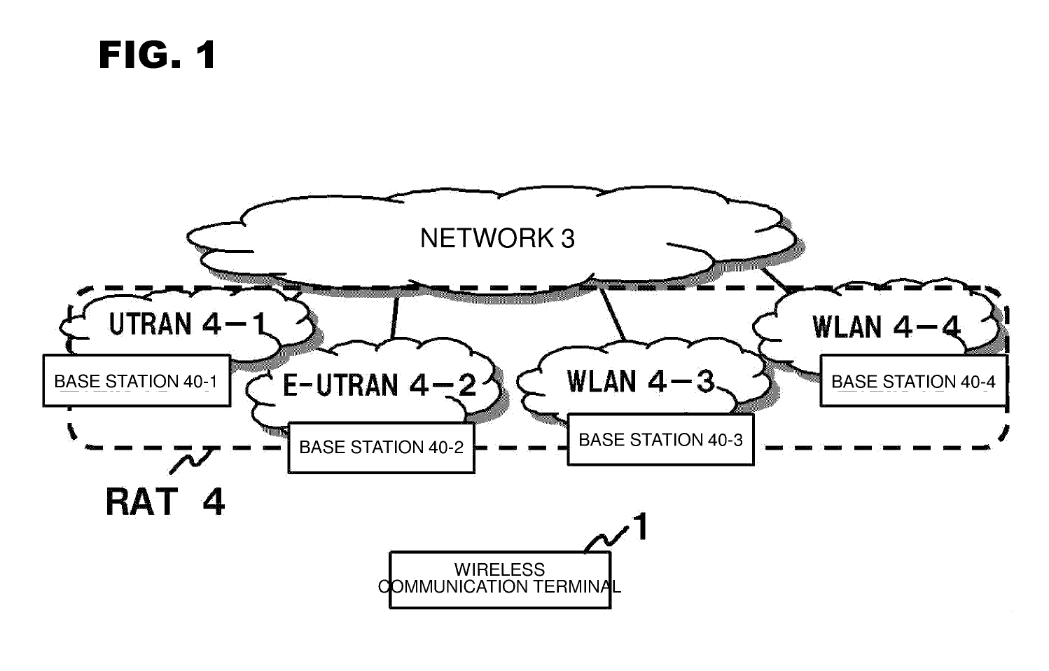

FIG. 1 shows an example of a system configuration of the first exemplary embodiment of the present invention.

The wireless communication terminal 1 communicates with a network 3 via a RAT 4. The RAT 4 comprises, for example, an UTRAN (UMTS (User Mobile Telecommunications System) Terrestrial Radio Access Network) 4-1, E-UTRAN (Evolved Universal Terrestrial Radio Access Network) 4-2, or WLAN (Wireless Local Area Network) 4-3, 4-4. It is to be noted that the RAT 4 shown in FIG. 1 is an example, and the wireless communication terminal 1 can also communicate by other RATs (for example, WiMAX (Worldwide Interoperability for Microwave Access) or the like).

The wireless communication terminal 1, for example, is an apparatus having a communication function, such as a mobile telephone, a personal computer, a mobile router, or the like. It is to be noted that the mobile router, for example, is a terminal that relays between a cellular line and a wireless LAN network. A mobile telephone, for example, is connected by a mobile router and a wireless LAN, and is connected to a cellular line via the mobile router.

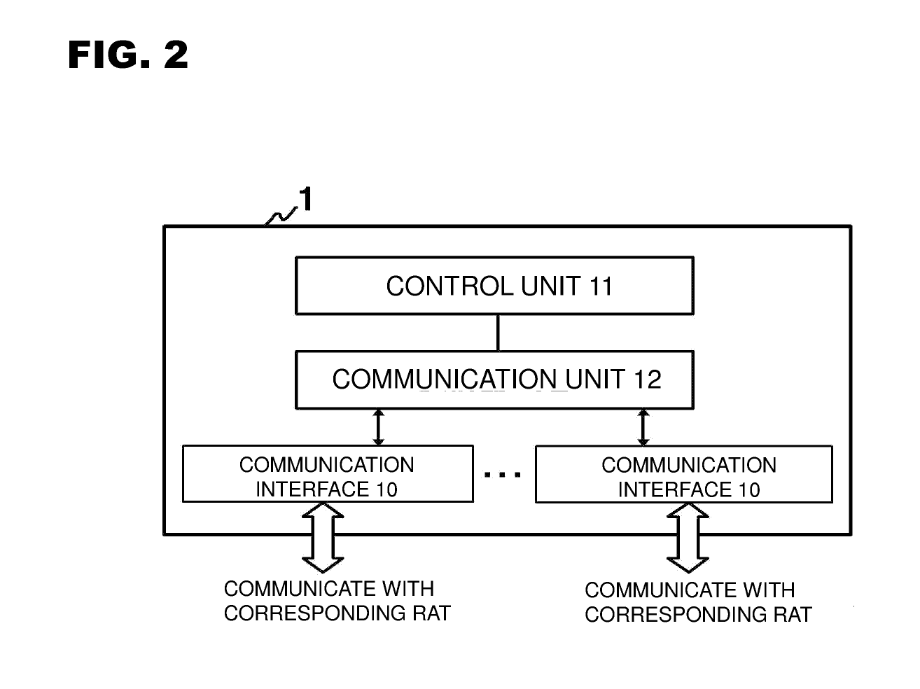

FIG. 2 shows an example of a configuration of the wireless communication terminal 1.

The wireless communication terminal 1 has a plurality of communication interfaces 10, a control unit 11, and a communication unit 12. Each communication interface 10 handles at least one of a plurality of wireless access schemes. For example, a communication interface 10(A) handles E-UTRAN 4-2, and a communication interface 10(B) handles IEEE 802.11a, 802.11b, 802.11g, 802.11n and the like.

The communication interface 10, for example, is an antenna. Each communication interface 10 handles at least one of the plurality of RATs. For example, a communication interface 10 handles a specific RAT (for example, UTRAN 4-1), and the wireless communication terminal 1 communicates by the specific RAT (for example, UTRAN 4-1) via that communication interface 10. For example, a communication interface 10 handles a plurality of RATs (for example, WLAN 4-2, 4-3), and the wireless communication terminal 1 communicates by any of the plurality of RATs handled via that communication interface 10. Furthermore, one apparatus (for example, an antenna) may have a configuration having a plurality of communication interfaces 10.

In a case of communicating by any of the RATs, the communication interface 10 communicates via a base station 40 that handles the RAT in question.

The control unit 11 has a function to display information representing a plurality of wireless access schemes by a list 100 according to a priority order. The control unit 11, for example, displays the list 100 on a display-apparatus of the wireless communication terminal 1. The control unit 11 notifies the communication unit 12 of a wireless access scheme selected by the user from the displayed list 100.

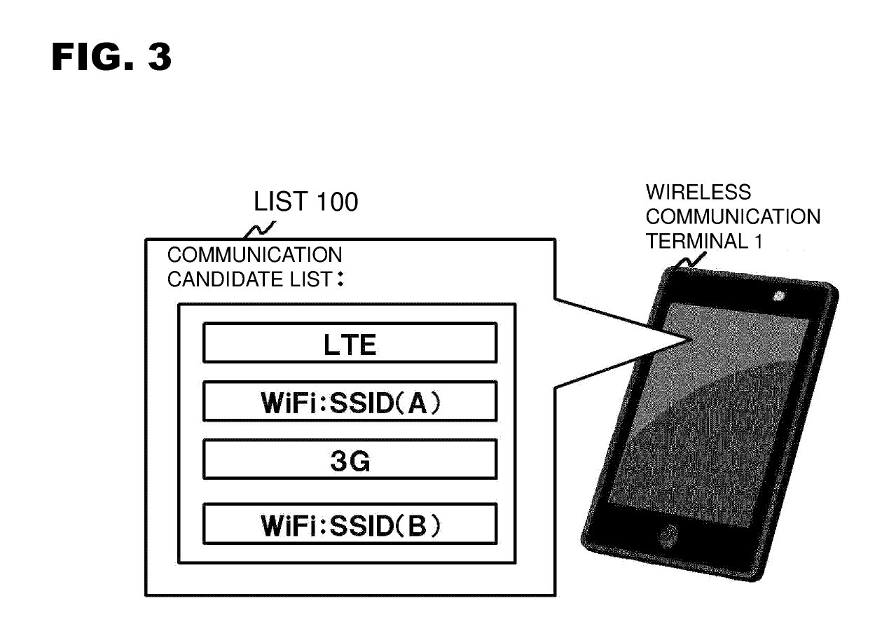

FIG. 3 shows an example of the list 100 displayed by the control unit 11.

In the example of FIG. 3, LTE (Long Term Evolution) for an E-UTRAN, WiFi, and 3G for an UTRAN are displayed according to the list 100 as wireless access schemes. WiFi is displayed, for example, together with an SSID (Service Set Identifier). In the example of FIG. 3, the wireless access scheme with the highest priority order is displayed, for example, at the top of the list 100. In the example of FIG. 3, “LTE” has the highest priority order, and “WiFi: SSID (B)” has the lowest priority order. Note that FIG. 3 is an example, and the list 100 displayed by the control unit 11 is not limited to FIG. 3.

The control unit 11, for example, displays the list 100 at arbitrary timing. It is possible for the control unit 11 to display the list 100 automatically at arbitrary timing.

The control unit 11, for example, may display the list 100 in response to status related to the wireless communication terminal 1 changing. The priority order of the wireless access scheme is determined, for example, according to status related to the wireless communication terminal 1. Therefore, the control unit 11 can display the list 100 according to the priority order, in response to a change of status related to the wireless communication terminal 1.

The status related to the wireless communication terminal 1, for example, is status related to movement of the wireless communication terminal 1, such as location of the wireless communication terminal 1, communication quality or the like. The control unit 11, for example, displays the list 100 in response to the status changing, accompanying movement of the wireless communication terminal 1.

The status related to the wireless communication terminal 1, for example, is status related to a communication operation of the wireless communication terminal 1, such as a communication charge billed to the wireless communication terminal 1, cumulative communication volume of the wireless communication terminal 1, type of application used in communication and the like. The control unit 11, for example, displays the list 100 in response to the status changing, accompanying a communication operation of the wireless communication terminal 1.

The control unit 11, for example, may display the list 100 in response to a prescribed operation being performed by the user.

The communication unit 12 has a function to communicate using a communication interface corresponding to the wireless access scheme selected from the displayed list 100. In a case where the selected wireless access scheme is not available, the communication unit 12 may communicate using a communication interface corresponding to a wireless access scheme of priority next in order to that of the selected wireless access scheme.

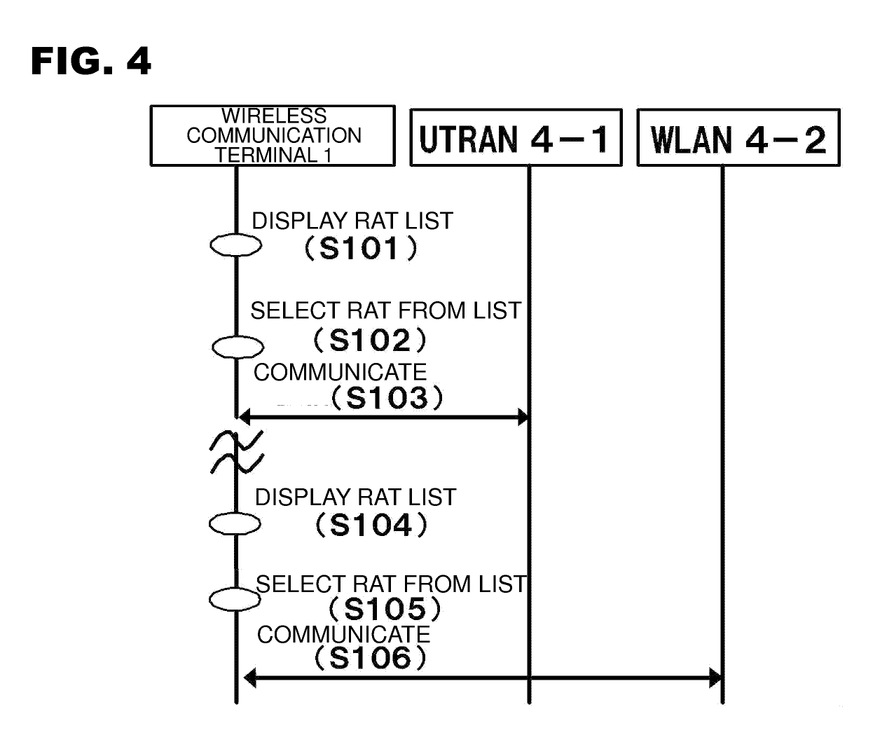

A sequence diagram of FIG. 4 shows an operational example of the first exemplary embodiment.

The wireless communication terminal 1, for example, displays information representing a wireless access scheme according to the list 100 according to the priority order, at arbitrary timing (step S101).

The user of the wireless communication terminal 1 selects the wireless access scheme from the list 100 (step S102). The wireless communication terminal 1 communicates using a communication interface corresponding to the wireless access scheme selected from the displayed list 100 (step S103).

The wireless communication terminal 1 repeats the abovementioned operations (step S104 to S106). For example, the wireless communication terminal 1 displays the list 100 in response to the priority order of the wireless access scheme changing according to a change in status related to the wireless communication terminal 1, and recommends to the user that the wireless access scheme be switched.

### Second Exemplary Embodiment

In a second exemplary embodiment, a description is given of an example of a policy for determining a priority order of a wireless access scheme. The policy corresponds to status related to a wireless communication terminal 1. That is, the wireless communication terminal 1 displays a list 100 according to a priority order determined based on the status related to the wireless communication terminal 1. The status related to the wireless communication terminal 1, for example, is a status that changes in accordance with movement of the wireless communication terminal, a status that changes in accordance with a communication operation of the wireless communication terminal 1, a status that changes in accordance with a communication environment of the wireless communication terminal 1, or the like.

Since the priority order of the wireless access scheme may be determined based on various policies as exemplified in the second exemplary embodiment, the present invention can present alternatives based on various points of view to a user. It is to be noted that a method of determining the priority order is not limited to an example shown in the second exemplary embodiment.

A description is given below of an example in which a control unit 11 determines the priority order of a wireless access scheme, making reference to the drawings. In this regard, an apparatus outside of the wireless communication terminal 1 may determine the priority order and notify the wireless communication terminal 1. The user may set the priority order in the wireless communication terminal 1.

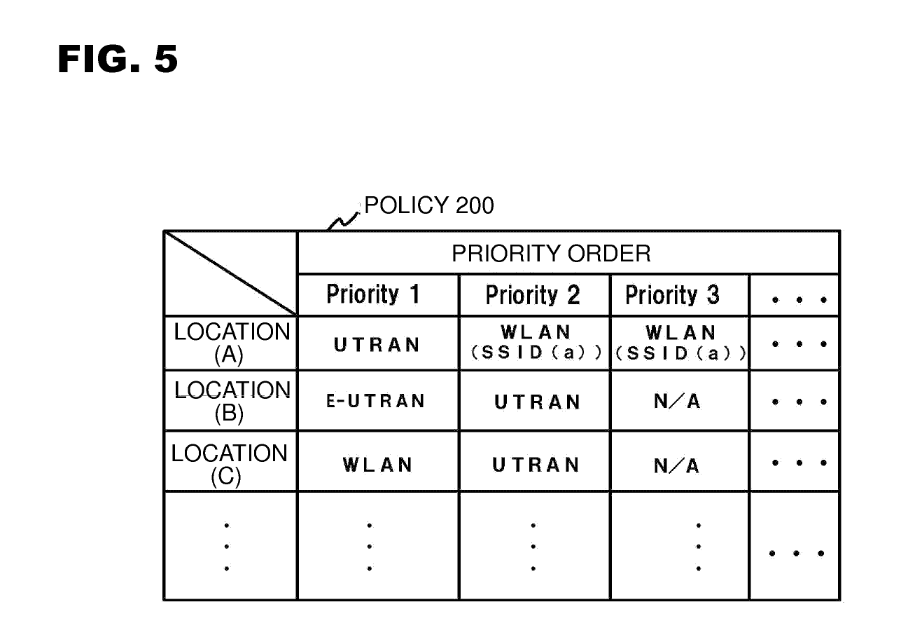

FIG. 5 shows an example of a policy 200 used when the priority order is determined based on the location of the wireless communication terminal 1. It is to be noted that the location of the wireless communication terminal 1, for example, is given by GPS (Global Positioning System) coordinates, a communication area in which the wireless communication terminal 1 is present, or the like. For example, the control unit 11 uses a GPS function of the wireless communication terminal 1 to obtain the location of the wireless communication terminal 1. For example, the control unit 11 refers to the policy 200 to determine the priority order based on the obtained location information.

An available wireless access scheme may change in accordance with the location of the wireless communication terminal 1. The priority order of the wireless access scheme is determined, for example, in response to the available wireless access scheme changing along with movement of the wireless communication terminal 1.

For example, in the example of FIG. 5, in a case where the wireless communication terminal 1 is at location (C), since there is a WiFi access point that the wireless communication terminal 1 can use free of charge, the priority order of WLAN is set to be higher than a cellular network (for example, UTRAN). For example, in the example of FIG. 5, in a case where the wireless communication terminal 1 is at location (A), since the communication quality of the cellular network (for example, UTRAN) is better than the communication quality of the WLAN, the priority order of the cellular network is set to be higher than the WLAN. In a case where the wireless communication terminal 1 is at location (B), for example, a plurality of cellular networks (for example, E-UTRAN and UTRAN) are available. Since the communication speed of an E-UTRAN is faster than a UTRAN, the priority of the E-UTRAN is set to be higher than the UTRAN.

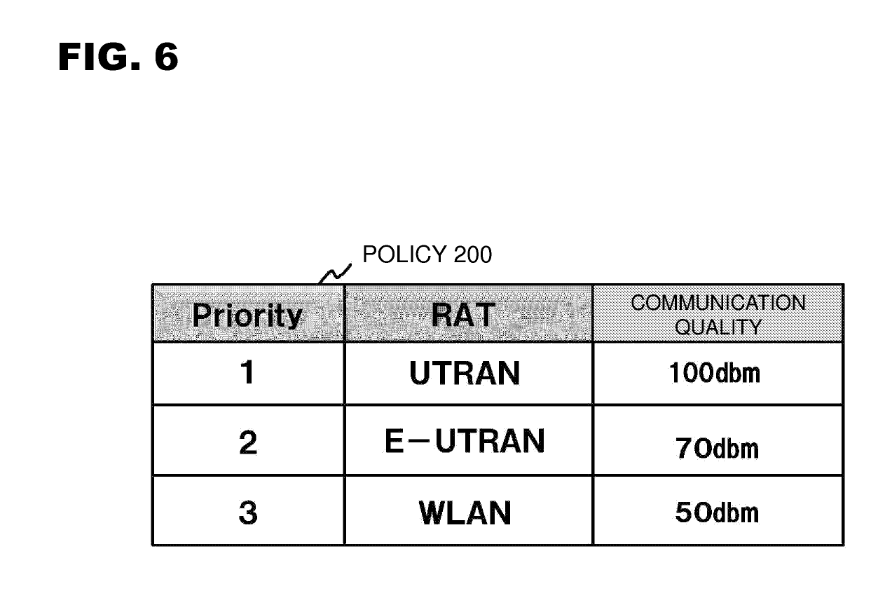

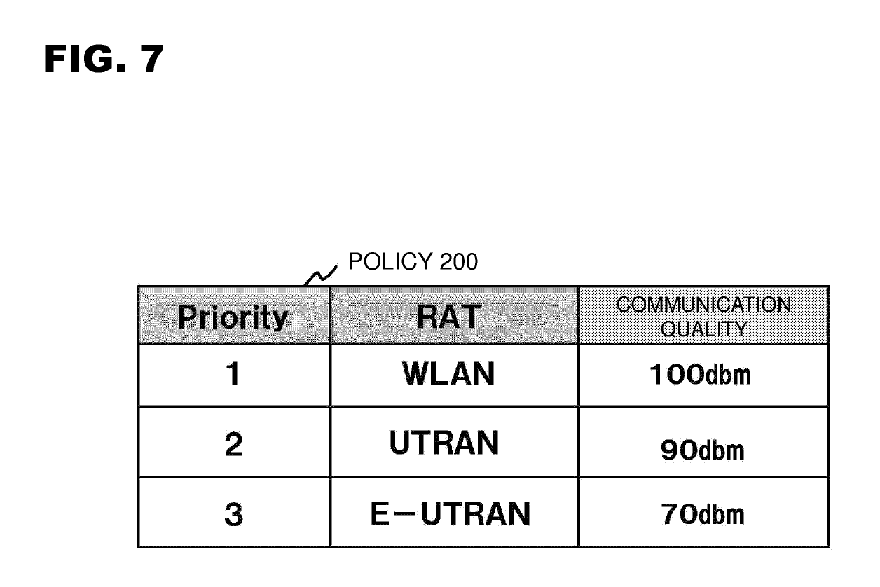

FIG. 6 and FIG. 7 show examples of policies 200 used when the priority order is determined based on the communication quality. The communication quality, for example, is represented by “dBm” (decibel milliwatt), which is a unit representing signal level in a communication line. For example, the control unit 11 uses respective communication interfaces 10 to measure signal level of a wireless access scheme corresponding to each of the communication interfaces 10 and to determine the priority order based on the measured signal level.

In the examples of FIG. 6 and FIG. 7, the priority orders of the wireless access schemes are set such that the better the communication quality of a wireless access scheme, the higher the priority order. In the example of FIG. 6, since the communication quality of the UTRAN is best, the priority order of the UTRAN is set to be highest. It is assumed that the communication quality changes in accordance with movement of the wireless communication terminal 1. FIG. 7 shows an example in which the communication quality changes along with movement of the wireless communication terminal 1. According to the communication quality of the WLAN becoming highest by movement of the wireless communication terminal 1, the priority order of the WLAN is set to be highest.

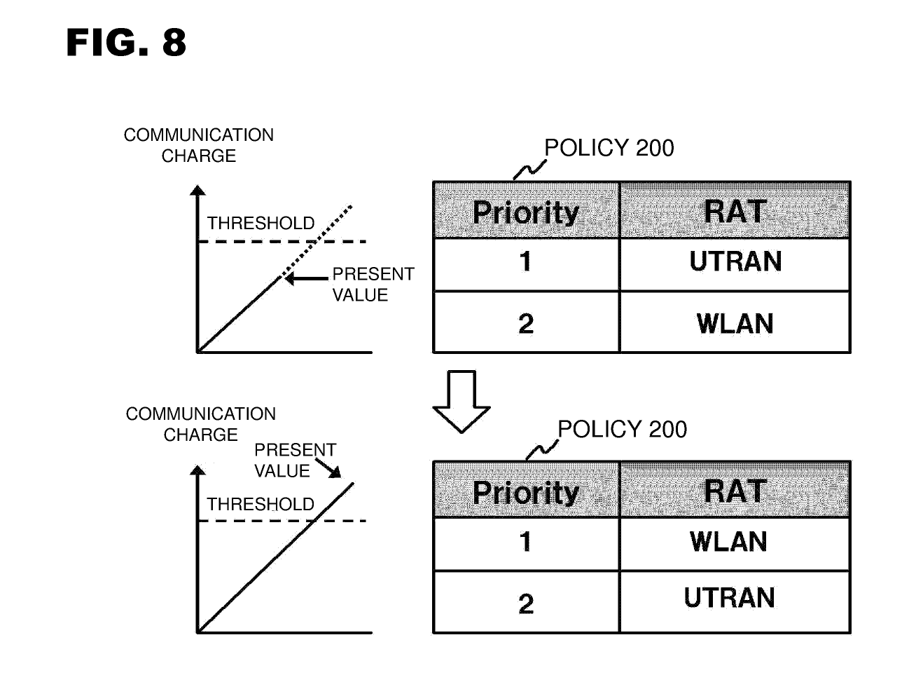

FIG. 8 shows an example of a policy 200 used when the priority order of the wireless access scheme is determined in accordance with communication charge.

In a case where a user of the wireless communication terminal 1 uses a usage based billing system to perform data communication by a cellular network, the communication charge paid by the user to a communications operator depends on the accumulated communication volume. The accumulated communication volume is the communication volume, for example, that is accumulated within a prescribed time. The accumulated communication volume may be the accumulated communication volume per day, per week, per month or the like, or may be the accumulated communication volume for a time unit (for example, per 1 hour).

For example, the control unit 11 monitors the accumulated communication volume and calculates the communication charge based on the monitored communication volume. A determining agent for the priority order (for example, the control unit 11) may obtain the communication charge from the communications operator.

A graph as in FIG. 8 shows an example in which the communication charge increases in accordance with time. For example, while the communication charge is less than or equal to a prescribed threshold, the priority order of the cellular network (for example, UTRAN) is set to be higher than other wireless access schemes.

In a case where the communication charge is above the prescribed threshold due to an increase in the accumulated communication volume, for example, the priority order of a wireless access scheme (for example, WLAN) in which the communication charge is free or cheap is set to be higher than the cellular network. A wireless access scheme in which the communication charge is cheap, for example, is a wireless access scheme with a fixed charge, with the communication charge not depending on communication volume.

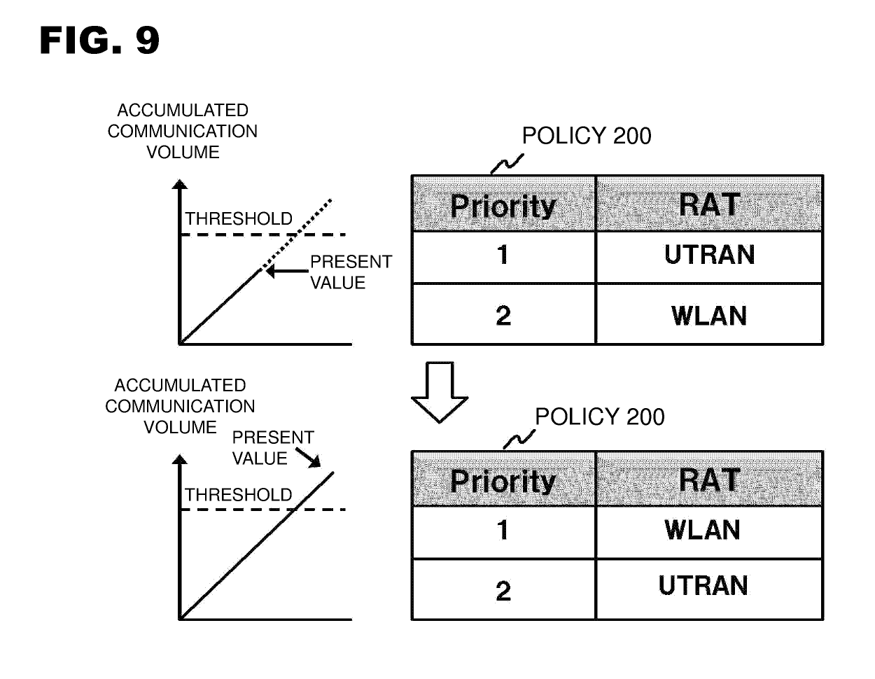

The priority order of the wireless access scheme may be determined based on the accumulated communication volume. FIG. 9 shows an example of a policy 200 used when the priority order of the wireless access scheme is determined based on the accumulated communication volume. For example, the control unit 11 monitors the accumulated communication volume of the wireless communication terminal 1.

A graph as in FIG. 9 shows an example in which the accumulated communication volume increases in accordance with time. For example, while the accumulated communication volume is less than or equal to a prescribed threshold, the priority order of the cellular network (for example, UTRAN) is set to be higher than other wireless access schemes.

In a case where the accumulated communication volume is above the prescribed threshold, for example, the priority order of a wireless access scheme (for example, WLAN) in which the communication charge is free or cheap is set to be higher than the cellular network. A wireless access scheme in which the communication charge is cheap, for example, is a wireless access scheme with a fixed charge, with the communication charge not depending on communication volume.

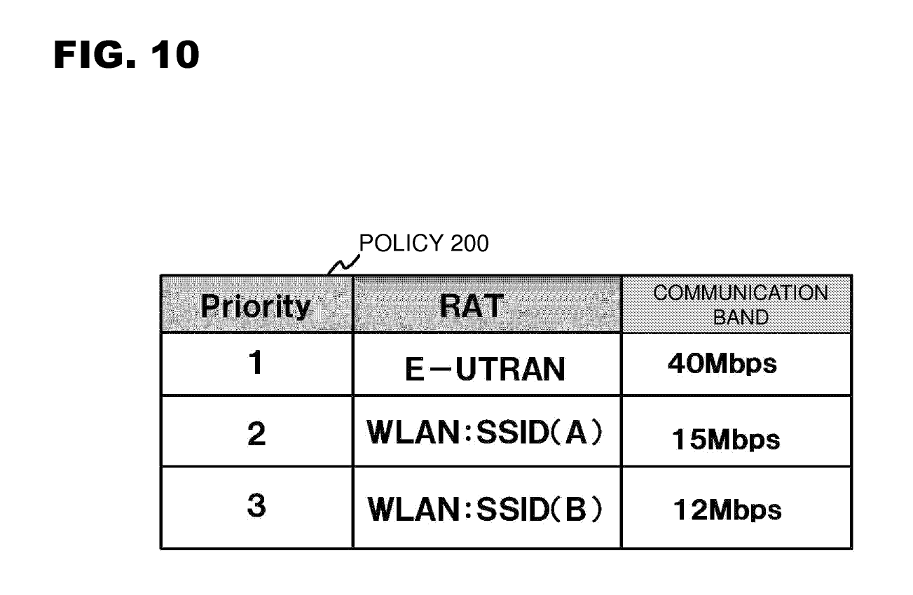

FIG. 10 shows an example of a policy 200 used when the priority order is determined based on communication band. The communication band, for example, is represented by “bps” (Bit Per Second) which is a unit representing data transmission speed. For example, the control unit 11 uses the respective communication interfaces 10 to measure data transmission speed of a wireless access scheme corresponding to each of the communication interfaces 10 and to determine the priority order based on the measured signal level (e.g., data transmission speed). The control unit 11, for example, measures the data transmission speed by round trip time required in transmitting and receiving a test packet.

In the example of FIG. 10, the priority order of the wireless access schemes is set such that the faster the data transmission speed of a wireless access scheme, the higher the priority.

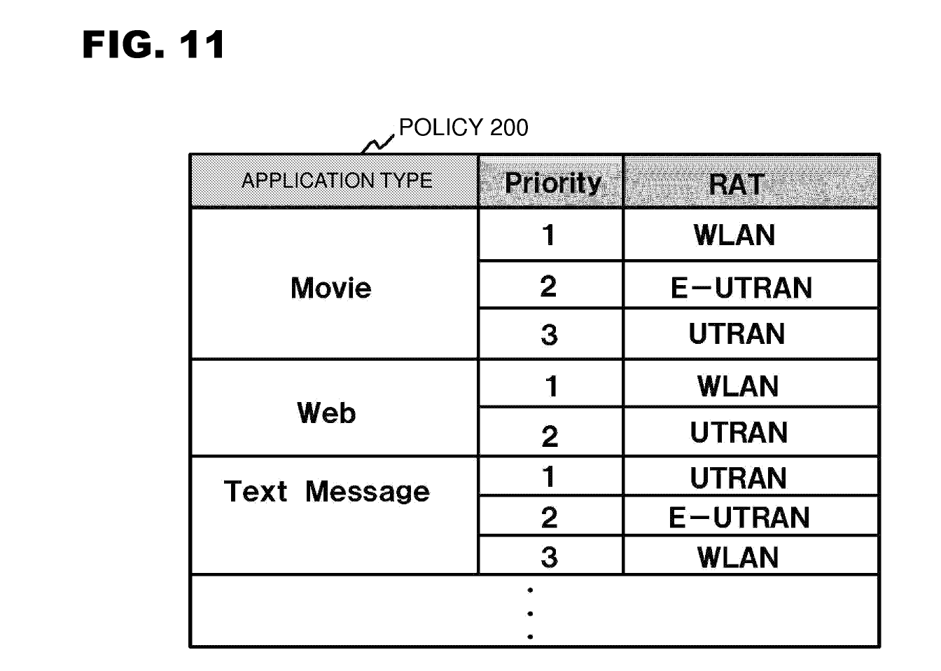

FIG. 11 shows an example of a policy 200 used when the priority order of the wireless access scheme is determined in accordance with application type. For example, the control unit 11 distinguishes the type of application executing communication, to determine the priority order of the wireless access scheme based on the policy 200. The control unit 11, for example, refers to a port number included in a packet, to determine the type of the application related to the communication.

In an application related to video browsing (“Movie” in FIG. 11), it is assumed that the communication volume is large. Therefore, for example, in order to avoid pressure on communication band of the cellular network, in the wireless access scheme used in the application related to video browsing, the priority order of a WLAN is set to be higher than a cellular network. In order to avoid a communication charge due to video browsing becoming high, the priority order of a wireless access scheme in which the communication charge is free or cheap is set to be high. A wireless access scheme in which the communication charge is cheap, for example, is a wireless access scheme with a flat rate, with the communication charge not depending on communication volume.

Similarly, in an application related to Web browsing (“Web” in FIG. 11), in order to avoid pressure on communication band of the cellular network, in the wireless access scheme used in the application related to video browsing, the priority order of a WLAN is set to be higher than a cellular network.

There are also applications where it is assumed that the user attaches importance to availability, such as with Text messaging, an SNS (Social Networking Service), or the like. In a wireless access scheme using this type of application, for example, the priority order is set giving consideration to communication stability rather than communication charge or the like. For example, the priority order of a wireless access scheme (for example, UTRAN) corresponding to a cellular network with a wide coverage area is set to be higher than other wireless access schemes.

In the example of FIG. 11, a priority order of wireless access scheme is prescribed for each application, but the priority order is determined, for example, based on any of the polices shown in FIG. 5 to FIG. 10. For example, with regard to an application (“Movie”) related to video browsing, the priority order for a RAT is determined based on a policy related to the communication charge as shown in FIG. 8.

Methods of determining the priority order of a wireless access scheme have been shown above, making reference to the drawings, but these methods are examples. Methods of determining the priority order of the wireless access scheme are not limited to the above described examples. Furthermore, methods of determining the priority order described with reference to the respective drawings can also be combined as appropriate.

In a case where, for example, the wireless access scheme by which the wireless communication terminal 1 establishes a connection is greater than or equal to a prescribed priority order determined by the abovementioned methods (a case of having the highest order, for example), the control unit 11 may stop a display of a list 100. The control unit 11, by displaying the list 100, can recommend switching to a wireless access scheme that is convenient for the user. However, it is envisaged that if the list 100 is displayed at very high frequency, the user will find it annoying. By the control unit 11 stopping the display of the list 100 in a case where the need to display the list 100 is low, the wireless communication terminal 1 can provide a comfortable usage environment for the user.

The user of the wireless communication terminal 1 can also set the policy 200 determining the priority order, in the control unit 11. For example, the user can set usage of the policy 200 determining the priority order in accordance with the location of the wireless communication terminal 1, in the control unit 11. Furthermore, the user can set usage of a plurality of types of policy 200 (for example, a policy determining the priority order according to location, and a policy determining the priority order in accordance with communication charge), in the control unit 11. The control unit 11, for example, determines the priority order of the wireless access scheme based on the set policy 200.

### Third Exemplary Embodiment

In a third exemplary embodiment, a description is given of various display examples of a list 100 of wireless access schemes. According to the display examples shown in the third exemplary embodiment, it is possible to recommend switching of a network to a user.

The third exemplary embodiment can be applied to any of the exemplary embodiments described above.

A control unit 11 of a wireless communication terminal 1 displays a list 100 based on a priority order determined by a method shown in the second exemplary embodiment. Below, a description is given of a display example of the list 100, in accordance with the drawings. In the third exemplary embodiment, a description is given of an example in which the control unit 11 determines the priority order of a wireless access scheme. In this regard, an apparatus outside of the wireless communication terminal 1 may determine the priority order and notify the wireless communication terminal 1. Furthermore the user may set the priority order in the wireless communication terminal 1.

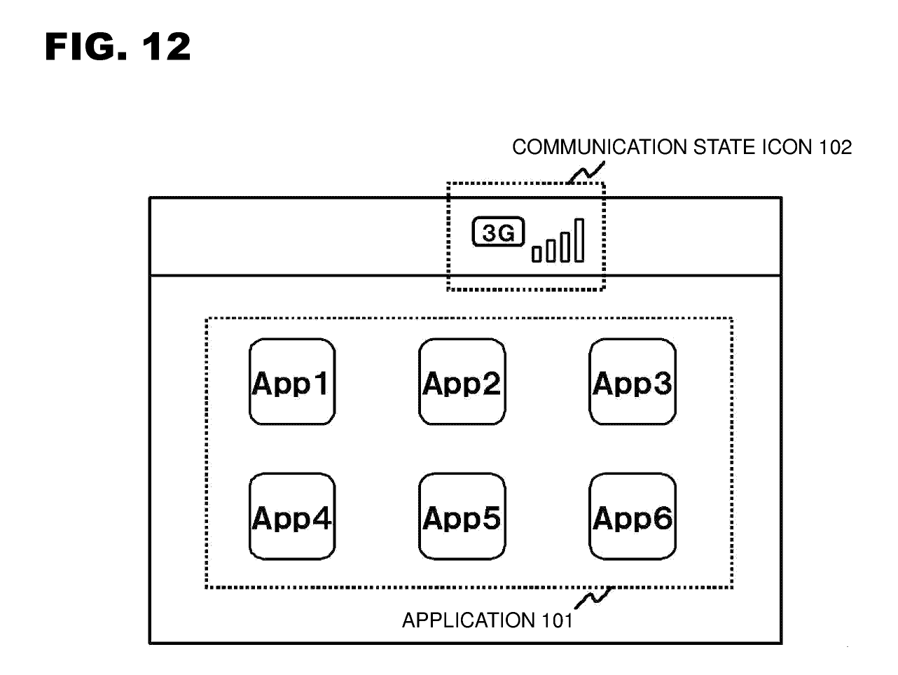

FIG. 12 is an example of a UI (User Interface) displayed on a display-apparatus of the wireless communication terminal 1. FIG. 12 is an example of a state in which the list 100 of the wireless access scheme is not displayed. Applications 101 and a communication state icon 102 are displayed on the display-apparatus of the wireless communication terminal 1. The display of the display-apparatus is an example, and content displayed in the wireless communication terminal 1 is not limited to the example shown in FIG. 12.

The applications 101, for example, are displayed by a plurality of icons (App1, etc., in FIG. 12). For example, by the user tapping an icon, an application corresponding to the tapped icon is started.

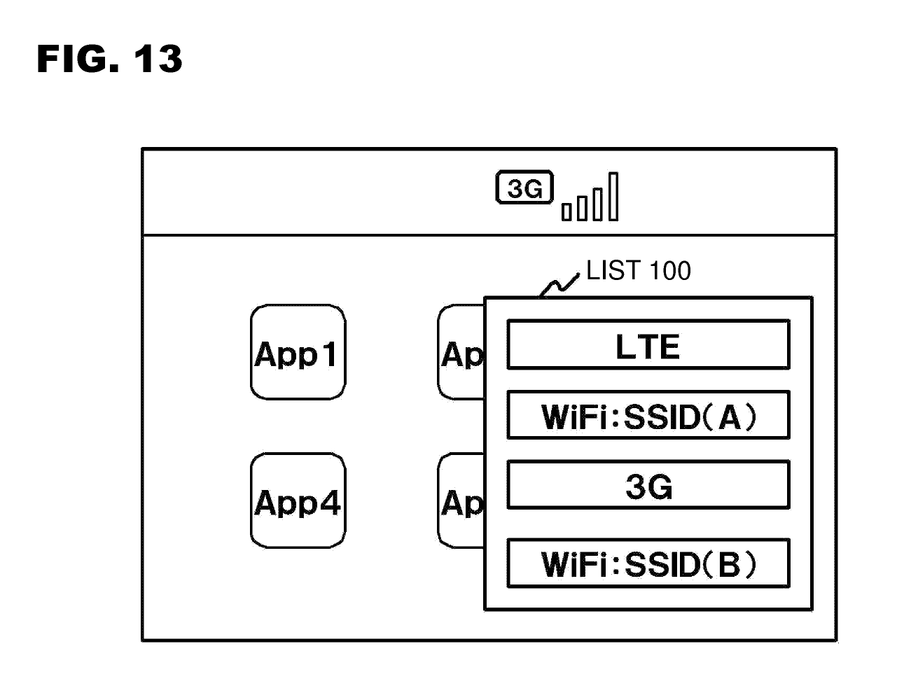

FIG. 13 shows an example in which the control unit 11 causes the list 100 to automatically pop up, without depending on an operation of the user.

For example, the priority order of a wireless access scheme changes along with a change of status related to the wireless communication terminal 1. The status related to the wireless communication terminal 1, for example, changes according to movement of the wireless communication terminal 1 or a communication operation by the wireless communication terminal 1. The priority order of the wireless access scheme is determined, for example, based on an example described in the second exemplary embodiment, in accordance with the status related to the wireless communication terminal 1. The control unit 11, for example, automatically displays the list 100 on the display-apparatus, in a case where the priority order of the wireless access scheme is changed according to a change of status related to the wireless communication terminal 1.

By automatically displaying the list 100 in accordance with a change in priority order, the wireless communication terminal 1 can recommend selecting a better wireless access scheme to the user.

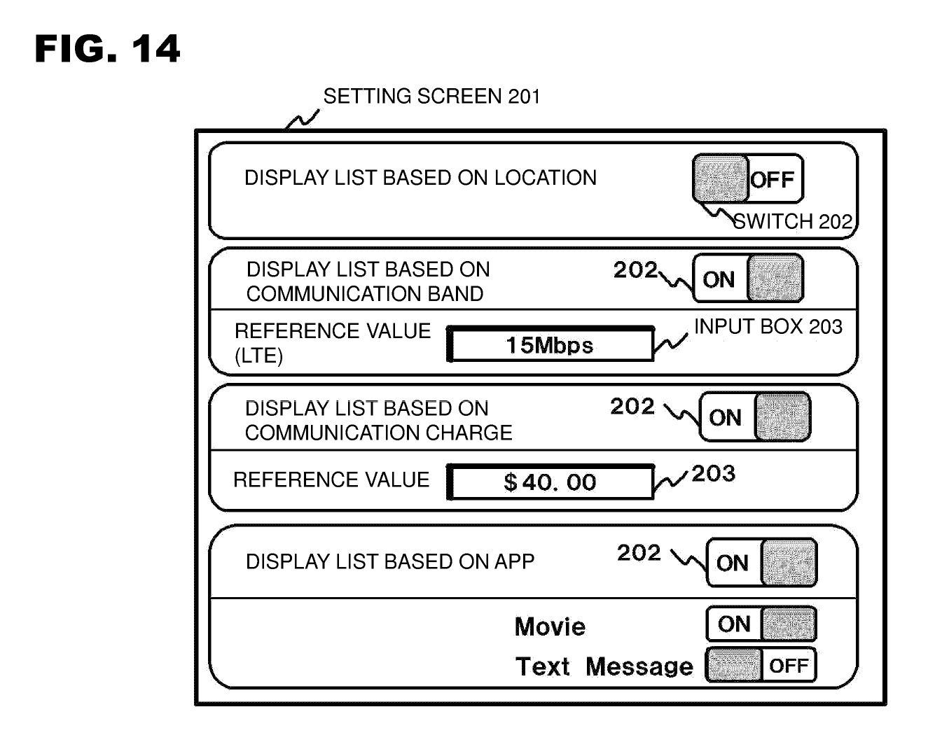

The control unit 11 may display the list 100 on the display-apparatus, based on a display condition set by the user of the wireless communication terminal 1. FIG. 14 shows an example of a setting screen 201 where the user inputs a display condition.

The user, for example, can make a setting to display the list 100 based on the location of the wireless communication terminal 1. For example, if a switch 202 corresponding to “display list based on location” of FIG. 14 is set to be “ON,” the list 100 is displayed when the wireless communication terminal 1 moves to a prescribed location. For example, the user can record location information corresponding to a prescribed location, in the wireless communication terminal 1. In a case where the switch 202 is “ON,” the control unit 11, for example, displays the list 100 when the wireless communication terminal 1 moves to a location corresponding to the location information recorded in the wireless communication terminal 1.

The user, for example, can make a setting to display the list 100 based on communication band of the wireless access scheme. For example, if a switch 202 corresponding to “display list based on communication band” of FIG. 14 is set to be “ON,” the list 100 is displayed when the communication band of a prescribed wireless access scheme is less than (or, is greater than) a prescribed reference value. For example, a user can set a prescribed reference value for each wireless access scheme. In the example of FIG. 14, “15 Mbps” is set as a reference value for “LTE.” For example, in a case where the communication band of “LTE” is less than “15 Mbps,” which is a reference value, the control unit 11 displays the list 100 including wireless access schemes outside of “LTE.” It is to be noted that in a case where the communication band is greater than the reference value, the control unit 11 may display the list 100. The user may set the reference value for a plurality of wireless access schemes. FIG. 14 shows an example of a setting for displaying the list 100 based on communication band, but a user may make a setting to display the list 100 based on communication quality (dBm).

The user, for example, can make a setting to display the list 100 based on communication charge. For example, if a switch 202 corresponding to “display list based on communication charge” of FIG. 14 is set to be “ON,” the list 100 is displayed when the communication charge is greater than a prescribed reference value. For example, a user can set a prescribed reference value related to the communication charge. In the example of FIG. 14, “$40.00” is set as a reference value for the communication charge. The reference value may be set for each wireless access scheme. For example, in a case where the communication charge exceeds “$40.00,” the control unit 11 displays the list 100 in which priority order is determined based on the communication charge, and recommends switching to a wireless access scheme with a cheap communication charge, to the user. FIG. 14 shows an example of a setting for displaying the list 100 based on communication charge, but a user may also make a setting to display the list 100 based on accumulated communication volume.

The user can make a setting to display the list 100 in accordance with a communication operation by a prescribed application. For example, if a switch 202 corresponding to “display list based on App” of FIG. 14 is set to be “ON,” the list 100 is displayed when a prescribed application is started, for example. The user, for example, can make a setting as to whether or not the list 100 is displayed for each application. In the example of FIG. 14, a setting related to an application (“Movie” in the drawing) related to video browsing is “ON,” and a setting related to an application (“Text Message” in the drawing) related to a text message is “OFF.” In the example of FIG. 14, in a case where the application related to video browsing is started, for example, the control unit 11 displays the list 100. The control unit 11, for example, determines the priority order of the wireless access scheme based on any of the policies 200 displayed in the second exemplary embodiment, to be displayed as the list 100.

It is to be noted that in a case where, for example, the wireless access scheme by which the wireless communication terminal 1 establishes a connection is greater than or equal to a prescribed order in the determined priority order (a case of having the highest order, for example), the control unit 11 need not display the list 100.

In a case where an apparatus outside of the control unit 11 determines the priority order, the control unit 11, for example, gives notification of the setting shown in FIG. 14 to the apparatus in question, and makes the apparatus determine the priority order.

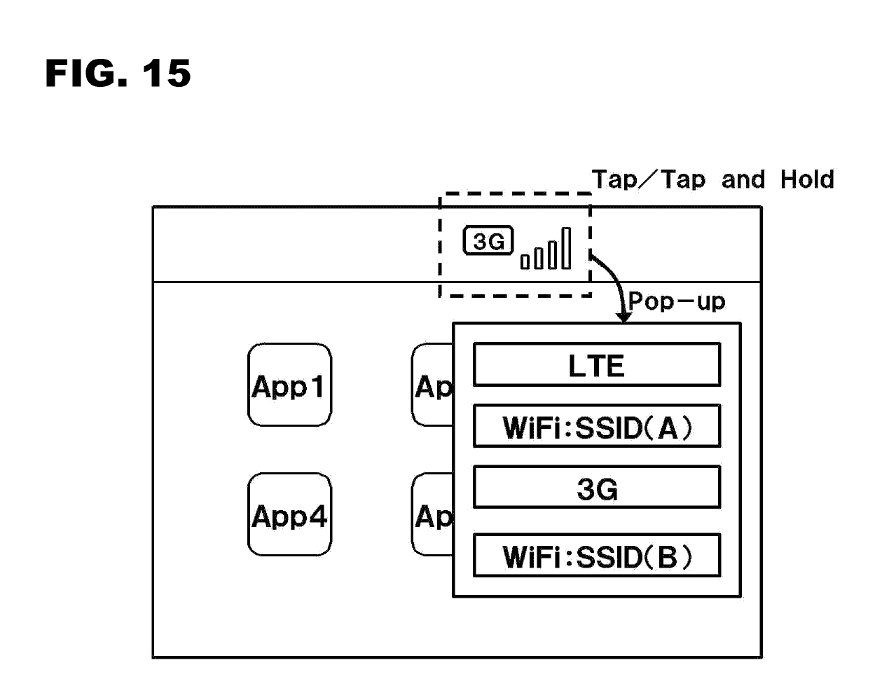

FIG. 15 shows an example in which the control unit 11 displays the list 100 in response to the communication state icon 102 being tapped. The control unit 11 may display the list 100 in response to the communication state icon 102 being pressed continuously (Tap and Hold). The communication state icon 102, for example, displays information related to the wireless access scheme presently being used and to communication quality.

The control unit 11, for example, displays a list 100 determined by a method shown in the second exemplary embodiment, in response to the user tapping the communication state icon 102. For example, the user sets in advance the policy 200 to be used, among policies shown in the second exemplary embodiment, in the control unit 11. The control unit 11 displays the list 100 with priority order determined according to the set policy 200, in response to the communication state icon 200 being tapped.

The control unit 11 may constantly display a plurality of icons corresponding to respective wireless access schemes, based on priority order, with respect to the communication state icon 102. For example, the control unit 11 may display a wireless access scheme in use, and a plurality of other wireless access schemes in accordance with priority order. The control unit 11, for example, changes the priority order of the wireless access scheme being displayed in response to the status of the wireless communication terminal 1 changing. The control unit 11, for example, displays the list 100 in accordance with priority order, in response to the communication state icon 102 being tapped (or pressed continuously).

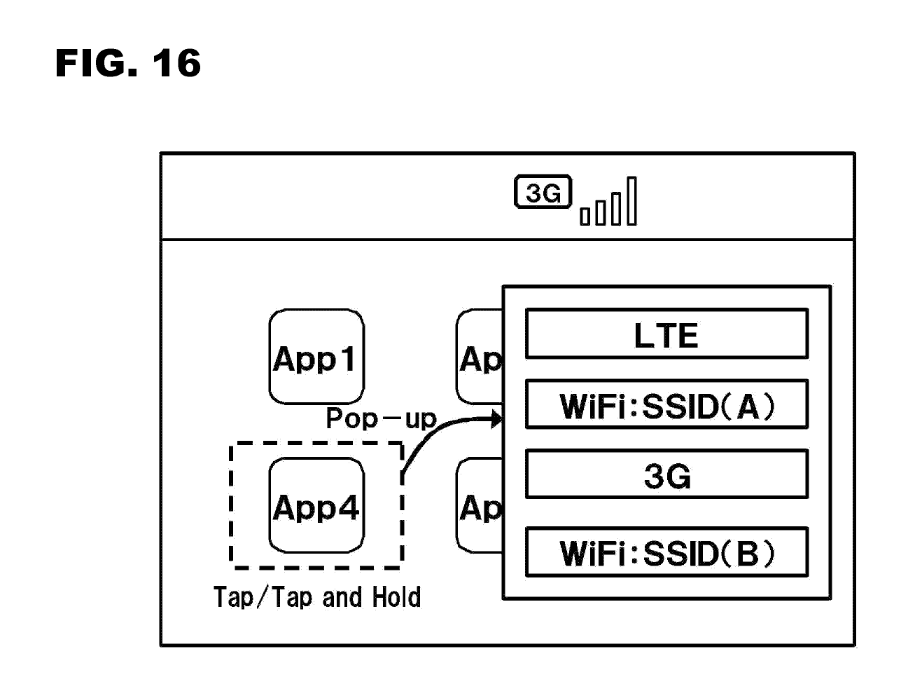

FIG. 16 shows an example in which the control unit 11 displays the list 100 in response to an icon of an application 101 performing communication being tapped. The control unit 11 may display the list 100 in response to the icon corresponding to the application 101 being pressed continuously (Tap and Hold).

The control unit 11, for example, displays the list 100 determined by a method shown in the second exemplary embodiment, in response to the user tapping the icon corresponding to the application 101 that performs communication. For example, the user sets in advance the policy 200 to be used, among policies shown in the second exemplary embodiment, in the control unit 11. The control unit 11 displays the list 100 with priority order determined according to the set policy 200, in response to the icon corresponding to the application 101 that performs communication being tapped.

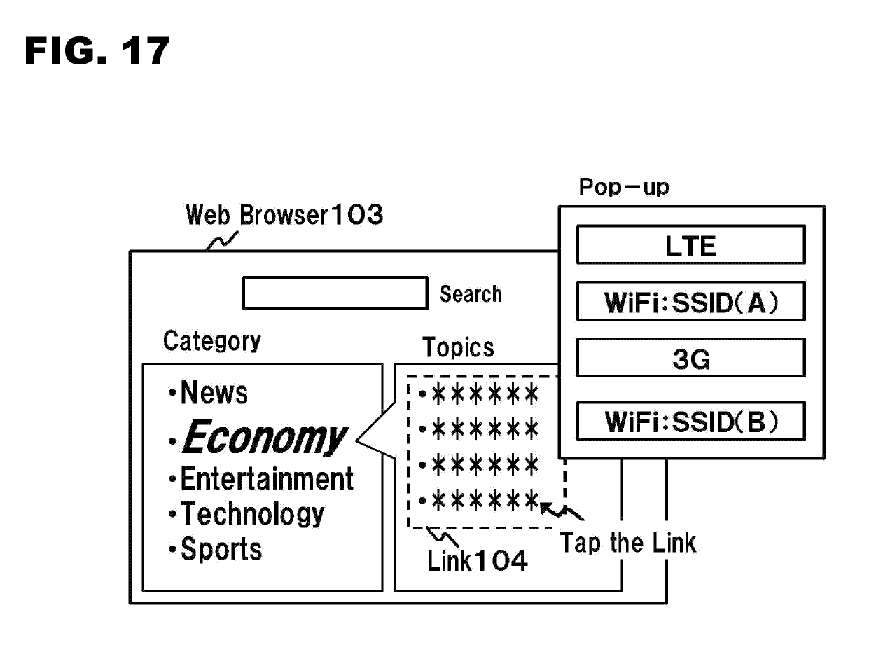

FIG. 17 shows an example in which the control unit 11 displays the list 100 in response to a link 104 displayed in a Web browser 103 being tapped. The control unit 11 may display the list 100 in response to the link 104 being pressed continuously (Tap and Hold).

The control unit 11, for example, displays the list 100 determined by a method shown in the second exemplary embodiment, in response to the link 104 being tapped. For example, the user sets in advance the policy 200 to be used, among policies shown in the second exemplary embodiment, in the control unit 11. The control unit 11 displays the list 100 with priority order determined according to the set policy 200, in response to the link 104 being tapped.

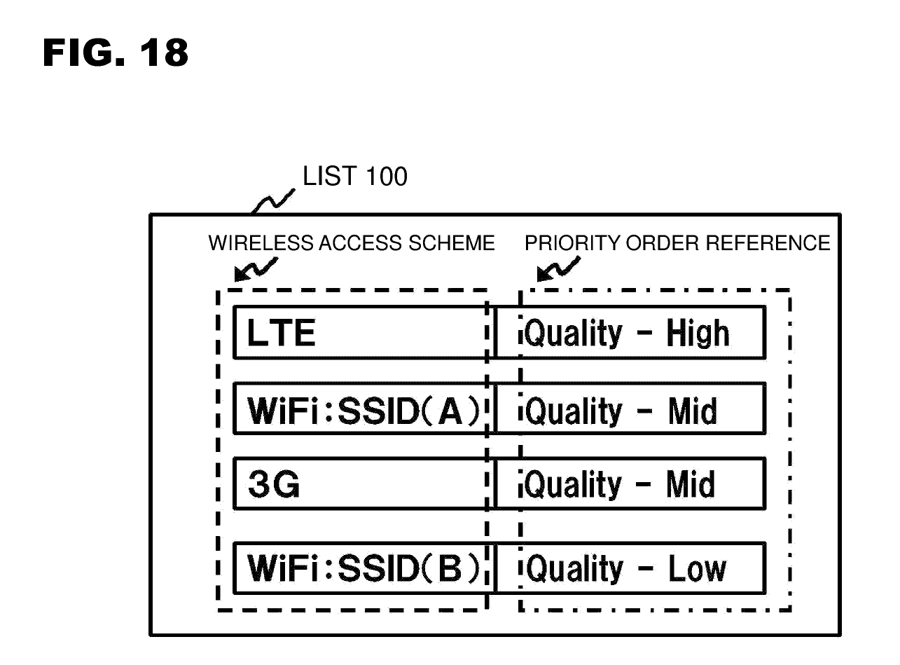

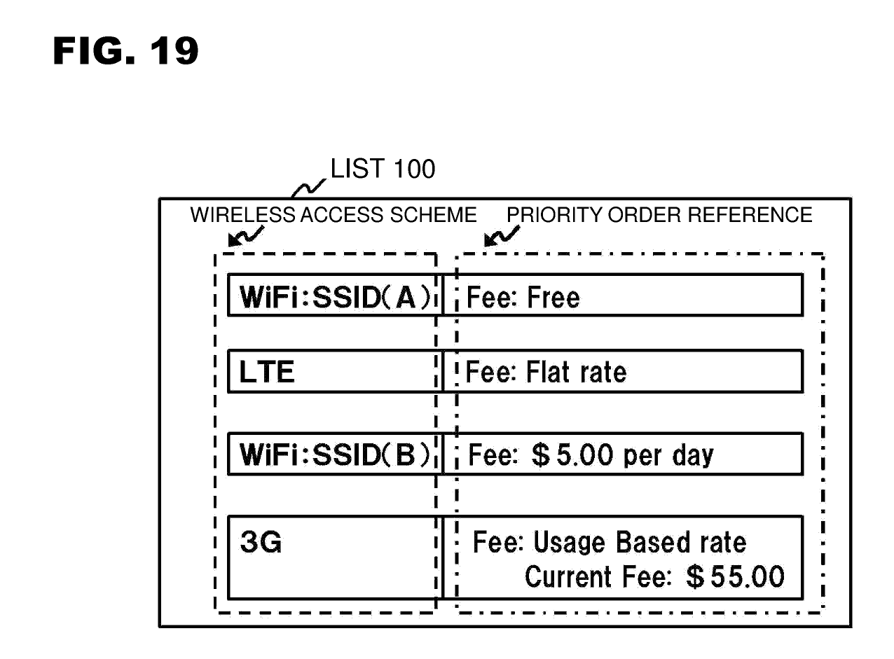

FIG. 18 and FIG. 19 show configuration examples of the list 100. In FIG. 18 and FIG. 19, the list 100 includes information forming the priority order reference. It is to be noted that FIG. 18 and FIG. 19 are examples, and the information forming the priority order reference is not limited to the examples of FIG. 18 and FIG. 19.

By displaying not only information representing the wireless access scheme but also information forming the priority order reference, the user can select a wireless access scheme with reference to more information.

FIG. 18 shows an example in which communication quality (“Quality” in the drawing) is displayed as the information forming the priority order reference. In a case where the priority order of the wireless access scheme is determined based on communication quality, the control unit 11 displays information representing the wireless access scheme and information related to communication quality.

FIG. 19 shows an example in which information related to communication charge is displayed as the information forming the priority order reference. In a case where the priority order of the wireless access scheme is determined based on the communication charge, the control unit 11 displays information representing the wireless access scheme and information related to the communication charge. For example, in a case where the priority order is determined such that the cheaper the communication charge, the higher the priority order of the wireless access scheme, the control unit 11 displays information related to billing method of each wireless access scheme. FIG. 19 shows an example in which “WiFi: SSID(A)” is free, “LTE” has a flat rate, “WiFi: SSID(B)” has a fee (or charge) of 5 dollars per day, and “3G” is usage based (current communication fee is 55 dollars). In the example of FIG. 19, “WiFi: SSID(A)” has the highest priority order, and “3G” has the lowest priority order.

FIG. 13 to FIG. 19 show examples in which the list 100 pops up, but methods of displaying the list 100 are not limited to a pop-up. Any method may be used for displaying the list 100. For example, the method may be one where the list 100 scrolls up from the bottom of a display-apparatus, or may be one where the list 100 scrolls down from the top of the display-apparatus. The method may also be one where the list 200 is displayed by sliding from either left or right of the display-apparatus.

### Fourth Exemplary Embodiment

A fourth exemplary embodiment illustrates a configuration example wherein a wireless communication terminal 1 determines a priority order for a wireless access scheme.

The fourth exemplary embodiment can be applied to any of the exemplary embodiments described above.

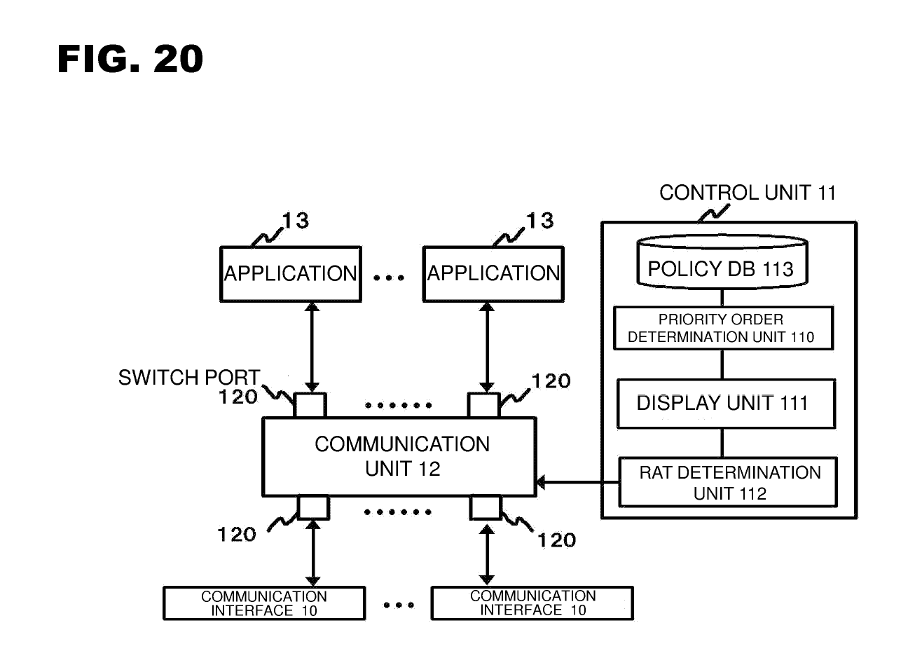

FIG. 20 shows a configuration example of the wireless communication terminal 1.

A control unit 11 includes a priority order determination unit 110, a display unit 111, a RAT determination unit 112, and a policy DB 113.

A communication unit 12 has a switch type function and has a function for switching a communication interface 10 in accordance with an instruction from the control unit 11. The communication unit 12 has a plurality of switch ports 120. Each application 13 and each communication interface 10 correspond to any one of the switch ports 120. The communication unit 12 manages a correspondence relationship between the applications 13 and the communication interfaces 10 based on an instruction from the RAT determination unit 112.

The priority order determination unit 110, for example, determines the priority order of a wireless access scheme by a method shown in the second exemplary embodiment. The policy DB 113 contains at least one policy 200 shown in the second exemplary embodiment. The priority order determination unit 110 refers to the policy DB 113 to determine the priority order of the wireless access scheme.

The display unit 111 displays a list 100 of the wireless access schemes with the priority order determined by the priority order determination unit 110.

The RAT determination unit 112 detects that a wireless access scheme has been selected from the displayed list 100. The RAT determination unit 112 instructs the communication unit 12 to communicate using a communication interface 10 corresponding to the selected wireless access scheme.

The RAT determination unit 112 may determine whether or not the selected wireless access scheme is available. The RAT determination unit 112, for example, instructs the communication unit 12 to measure the radio wave state using the communication interface 10 corresponding to the selected wireless access scheme. The RAT determination unit 112 determines whether or not the selected wireless access scheme is available in accordance with a result of measurement by the communication unit 12. The RAT determination unit 112, for example, instructs the communication unit 12 to communicate according to a wireless access scheme of next highest priority order, in a case where the selected wireless access scheme is unavailable. The RAT determination unit 112, for example, may use the display unit 111 to display that the selected wireless access scheme is unavailable and to display the list 100 excepting the wireless access scheme that is unavailable, and may recommend re-selection to the user.

### Fifth Exemplary Embodiment

A fifth exemplary embodiment shows an example in which creation of a list 100 of wireless access schemes and determination of priority order are executed by a control server 5.

The fifth exemplary embodiment may be applied to any of the exemplary embodiments described above.

By the control server 5 executing the creation of the list 100 and the determination of the priority order, load due to management by a wireless communication terminal 1 and a user of the wireless communication terminal 1 is reduced. For example, a communications operator may manage the control server 5.

The fifth exemplary embodiment may be applied to the exemplary embodiments described above.

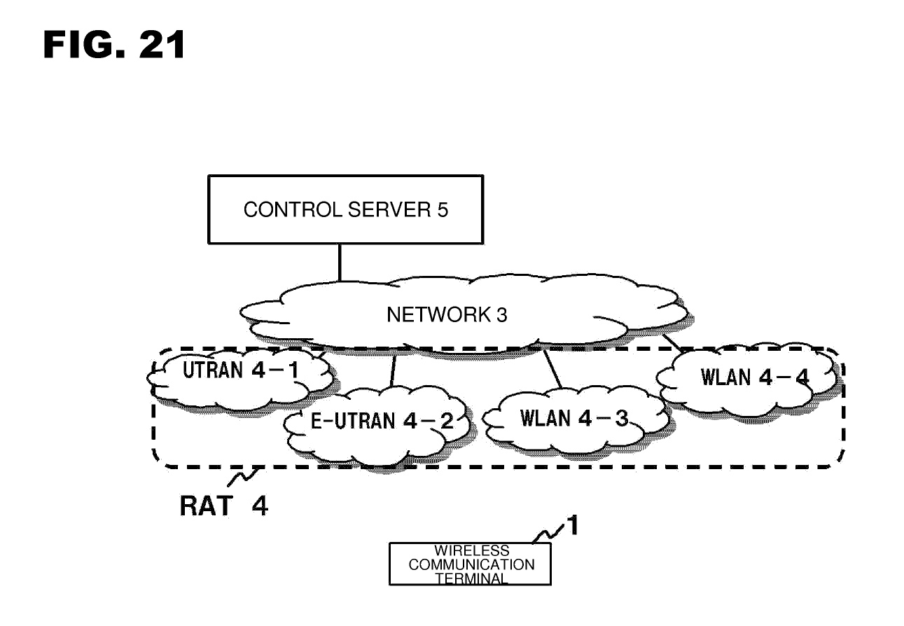

FIG. 21 shows an example of a system configuration of the fifth exemplary embodiment.

The control server 5 gives notification of the list 100 of wireless access schemes and the priority order to the wireless communication terminal 1.

The control server 5 is an apparatus that is physically separate from the wireless communication terminal 1. It is to be noted that the location at which the control server 5 is installed is not limited to that of FIG. 21, and installation is possible in an access network of each RAT. The control server 5 may be installed in a Data Center that can communicate with a network 3.

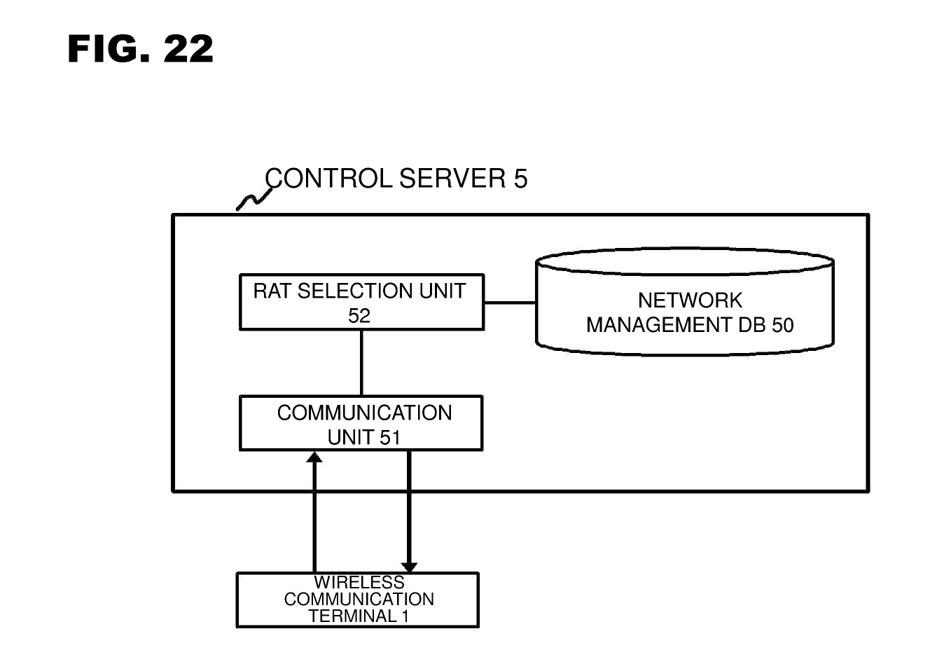

FIG. 22 shows an example of a configuration of the control server 5.

In the example of FIG. 22, the control server 5 notifies the wireless communication terminal 1 of candidate wireless access schemes appearing in the list 100 displayed by the wireless communication terminal 1.

The control server 5 includes a network management DB (Data Base) 50, a communication unit 51, and a RAT selection unit 52.

The communication unit 51 has a function for communicating with the wireless communication terminal 1. The wireless communication terminal 1 communicates with the communication unit 51, and gives notification to the control server 5 of information to be used for the control server 5 to select a wireless access scheme candidate. The wireless communication terminal 1, for example, gives notification of the location of the wireless communication terminal 1 and of user information (for example, user ID) of the wireless communication terminal 1. The wireless communication terminal 1, for example, may give notification of communication charges, measurement results of accumulated communication volume and communication quality of a wireless access scheme, and the like.

The RAT selection unit 52 refers to information notified by the wireless communication terminal 1 via the communication unit 51, to select a wireless access scheme candidate to be notified to the RAT wireless communication terminal 1.

The RAT selection unit 52, for example, refers to the network management DB 50 to select the wireless access scheme candidate.

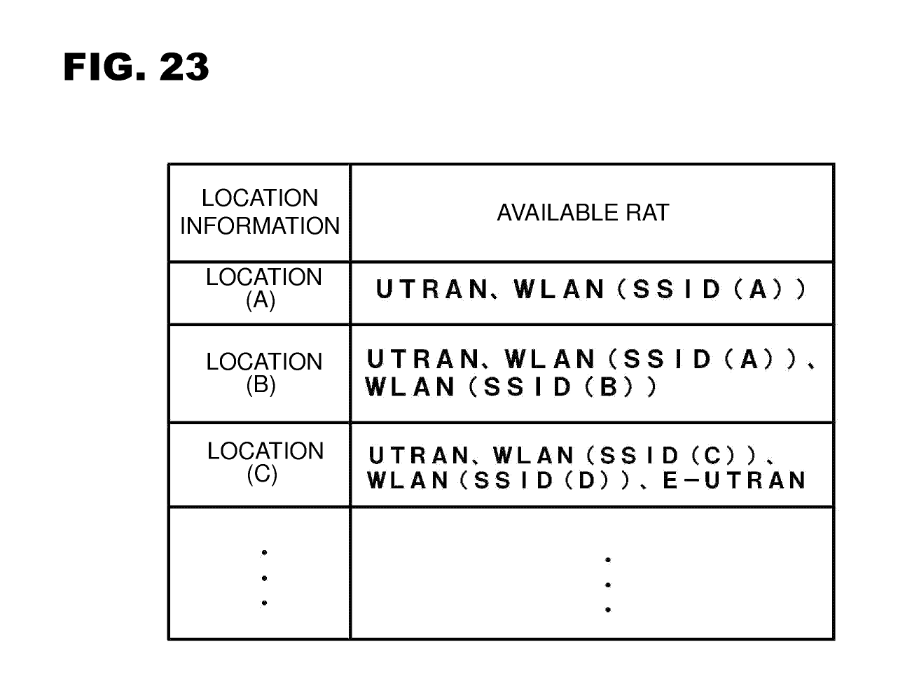

The network management DB 50 is a database that manages, for example, an available wireless access scheme for each location (for example, GPS coordinates or communication area). FIG. 23 shows an example of a data structure stored by the network management DB 50. The network management DB 50 manages information representing an available wireless access scheme for each location.

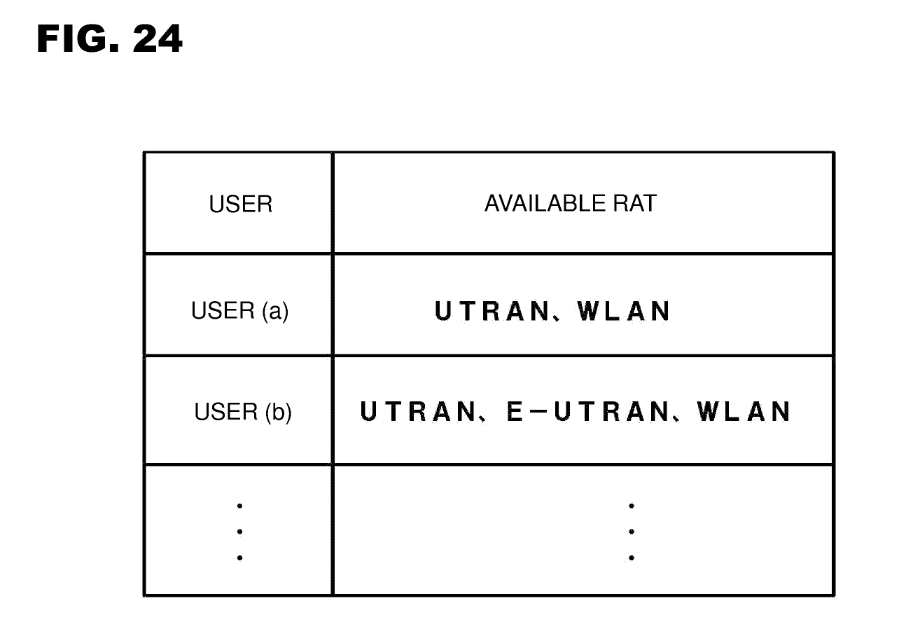

The network management DB 50, for example, may manage the wireless access schemes available for use by users of the wireless communication terminal 1, for each user of the wireless communication terminal 1. The wireless access schemes that are available to the wireless communication terminal 1 depend on a user's contract and the capability of the wireless communication terminal 1. FIG. 24 shows an example of a data structure stored by the network management DB 50. It is to be noted that the network management DB 50 may manage both data structures shown in FIG. 23 and FIG. 24. The network management DB 50 manages the wireless access schemes available to the user, for each information item (for example, user ID) related to the user.

The RAT selection unit 52, for example, refers to a database shown in FIG. 23 and FIG. 24, based on user information and location information notified by the wireless communication terminal 1, to retrieve an available wireless access scheme. By referring to FIG. 23 and FIG. 24, the RAT selection unit 52 can retrieve a wireless access scheme that is available to the user of the wireless communication terminal 1 at the present location. The RAT selection unit 52 gives notification to the wireless communication terminal 1 of the retrieved wireless access scheme.

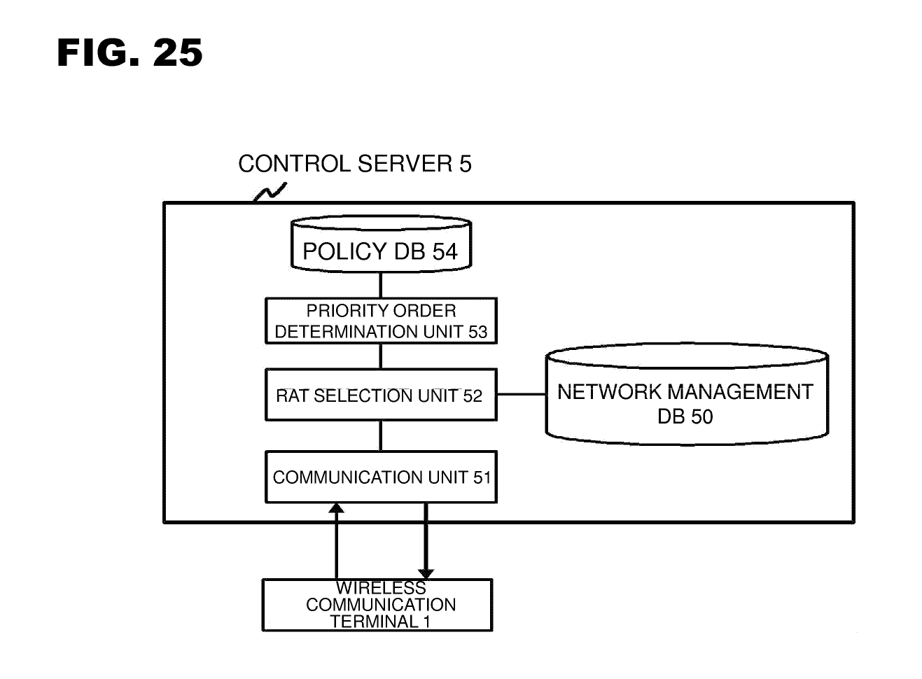

FIG. 25 shows another configuration example of the control server 5. The control server 5 shown in FIG. 25 creates the list 100 according to the priority order of the wireless access schemes, and gives notification to the wireless communication terminal 1 of the created list 100.

A priority order determination unit 53 determines the priority order of a wireless access scheme selected by the RAT selection unit 52 by referring to the network management DB 50, and creates the list 100. The priority order determination unit 53, for example, refers to information notified by the wireless communication terminal 1 (for example, location, user ID, communication charge, or measurement result of accumulated communication volume or communication quality of a wireless access scheme) to determine the priority order.

The priority order determination unit 53, for example, determines the priority order of the wireless access scheme by a method shown in the second exemplary embodiment. The priority order determination unit 53, for example, refers to the policy 200 contained in the policy DB 54 to determine the priority order. The policy DB 54, for example, contains at least one of the policies 200 shown in the second exemplary embodiment. The priority order determination unit 53, for example, may receive a setting by the user from the wireless communication terminal 1 as shown in FIG. 14, to determine the priority order based on the received setting.

Since the priority order determination unit 53 determines the priority order and creates the list 100, the load due to the wireless communication terminal 1 executing determination of priority order and creation of the list 100 is reduced.

### Sixth Exemplary Embodiment

A sixth exemplary embodiment illustrates an example in which the present invention is implemented by improving technology known as OpenFlow, which is a centrally controlled network architecture.

The sixth exemplary embodiment can be applied to any of the exemplary embodiments described above.

In OpenFlow, communication is recognized as end-to-end flow, and path control can be performed on a per-flow basis. Therefore by using OpenFlow in the present invention, it is possible to more flexibly control wireless access schemes in accordance with communication charges.

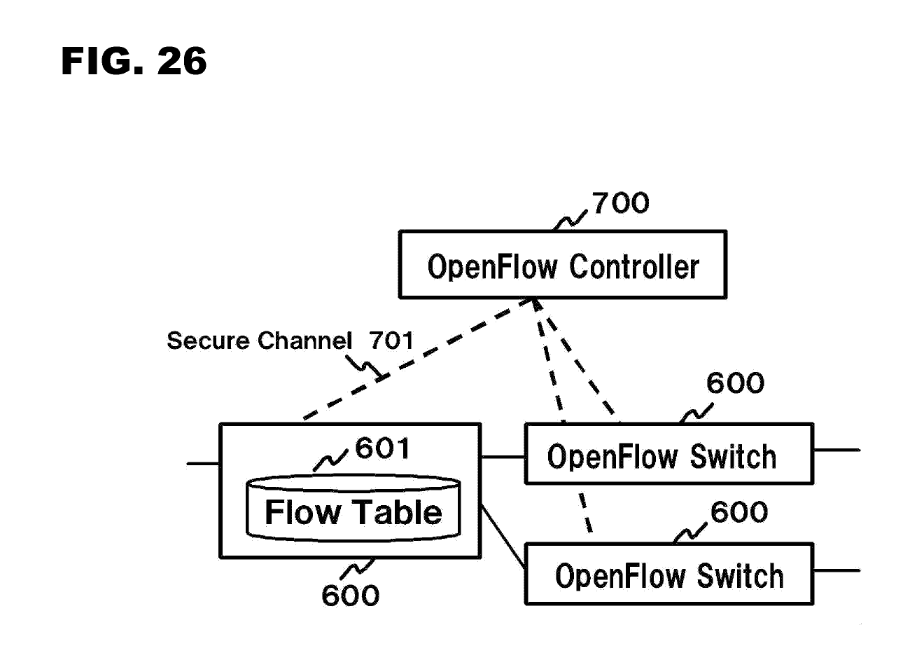

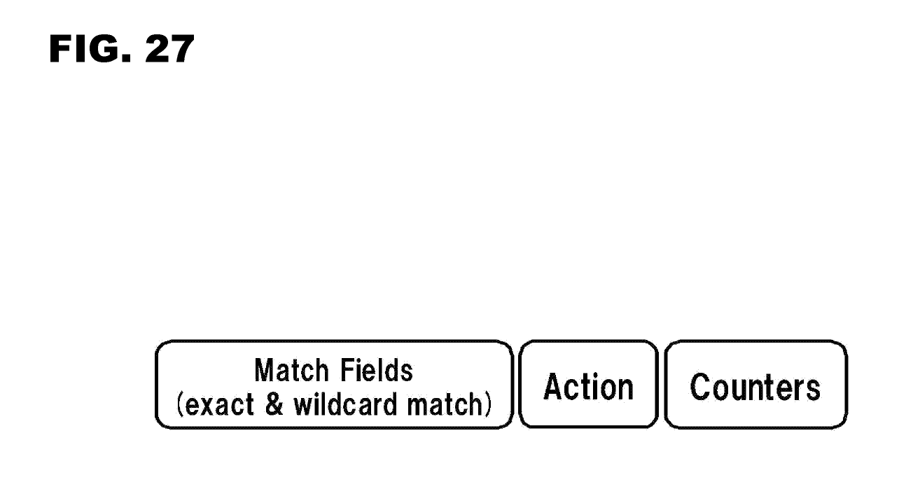

A description is given concerning OpenFlow, referring to FIG. 26 and FIG. 27.

FIG. 26 shows an outline of a communication system configured by OpenFlow technology. It is to be noted that a flow is, for example, a communication packet series group having a prescribed attribute (an attribute distinguished based on a destination or transmission source of a communication). An OpenFlow switch 600 is a network switch using OpenFlow technology. An OpenFlow controller 700 is an information processing apparatus that controls the OpenFlow switch 600.

The OpenFlow switch 600 communicates with the OpenFlow controller via a secure channel 701 arranged between itself and the OpenFlow controller 700. The OpenFlow controller 700 performs setting of a flow table 601 of the OpenFlow switch 600 via the secure channel 701. It is to be noted that the secure channel 701 is a communication path disposed in order to prevent bugging or manipulation of communication between a switch and a controller.

FIG. 27 shows a configuration example of respective entries (flow entries) of the flow table 601. A flow entry is composed of a matching rule for matching information (for example, destination IP address or VLAN ID) included in a header of a packet received by a switch, statistical information (Counters) for each packet flow, and actions (Actions) defining a processing method for a packet matching the matching rule.

On receiving a packet, the OpenFlow switch 600 refers to the flow table 601. The OpenFlow switch 600 searches for a flow entry that matches header information of the received packet. In a case where an entry matching the header information of the received packet is retrieved, the OpenFlow switch 600 processes the received packet in accordance with a processing method defined in an action field of the retrieved entry. The processing method has definitions of, for example, “forward the received packet from a prescribed port,” “drop the received packet,” “rewrite a part of the header of the received packet and forward from a prescribed port.”

On the other hand, in a case where an entry matching the header information of the received packet is not found, the OpenFlow switch 600, for example, forwards the received packet to the OpenFlow controller 700 via the secure channel 701. By forwarding the received packet, the OpenFlow switch 600 requests setting of a flow entry defining a processing method for the received packet, with respect to the controller.

The OpenFlow controller 700 determines a processing method for the received packet, and sets a flow entry including the determined processing method in the flow table 601. Thereafter, the OpenFlow switch 600 processes subsequent packets belonging to the same flow as the received packet in accordance with the set flow entry.

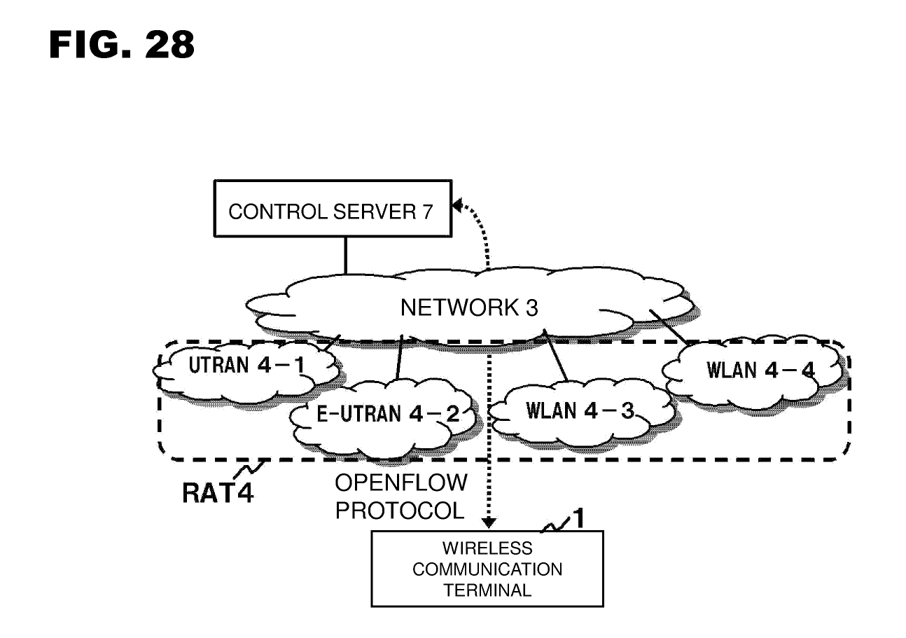

FIG. 28 shows an example of a communication system of the sixth exemplary embodiment of the present invention, configured by improving the abovementioned OpenFlow.

A control server 7 is configured by improving the OpenFlow controller. A wireless communication terminal 1 has a function configured by improving the OpenFlow switch. The wireless communication terminal 1 and the control server 7 communicate based on an OpenFlow protocol.

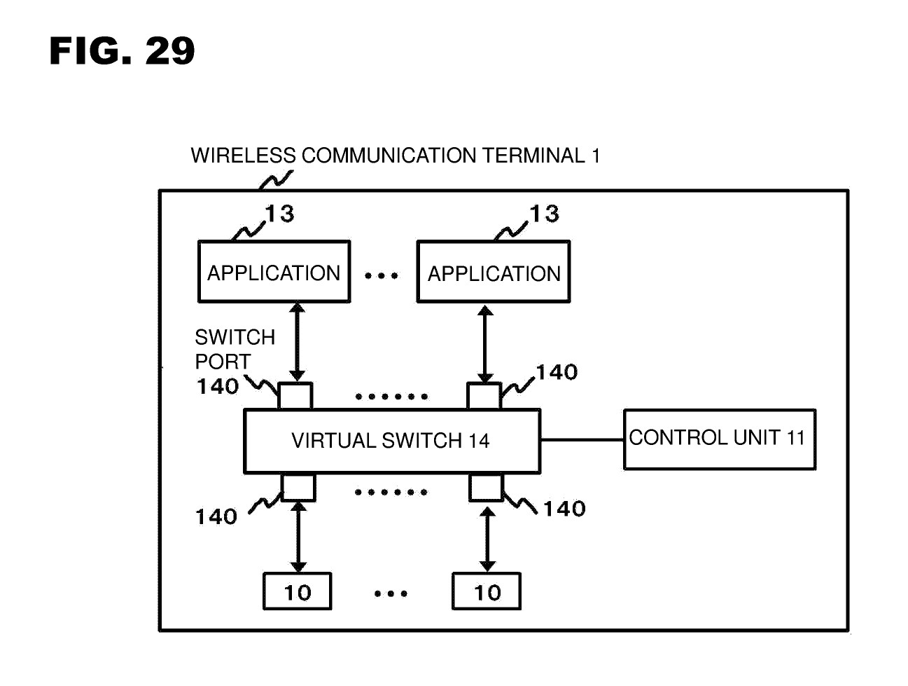

FIG. 29 shows a configuration example of the wireless communication terminal 1 of the sixth exemplary embodiment.

The wireless communication terminal 1 has a virtual switch 14 configured by improving the OpenFlow switch. The virtual switch 14 is configured by software, but the present invention may also include a hardware configuration.

The virtual switch 14 has a function similar to a communication unit 12 shown in FIG. 2 and FIG. 20. The virtual switch 14 has a function that operates in response to an instruction transmitted by the control server 7.

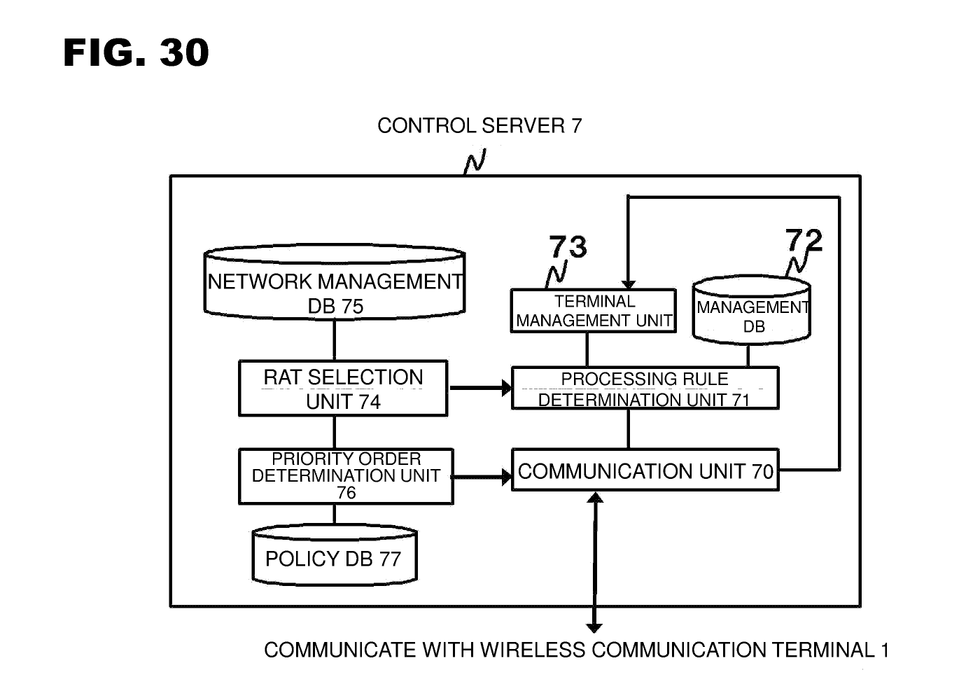

FIG. 30 shows an example of a configuration of the control server 7.

The control server 7 includes a communication unit 70, a processing rule determination unit 71, a management DB 72, a terminal management unit 73, a RAT selection unit 74, a network management DB 75, and a priority order determination unit 76.

The RAT selection unit 74, the network management DB 75, and the priority order determination unit 76 have a function similar to a control server 5 of the fifth exemplary embodiment. The RAT selection unit 74 refers to the network management DB 75 to retrieve a wireless access scheme that is available to the wireless communication terminal 1. The priority order determination unit 76 determines the priority order of a wireless access scheme selected by the RAT selection unit 74 by referring to the network management DB 50, and creates the list 100. The priority order determination unit 76, for example, determines the priority order of the wireless access scheme by a method shown in the second exemplary embodiment. The priority order determination unit 76 refers to policies 200 contained in a policy DB 77 to determine the priority order. The policy DB 77, for example, contains at least one of the policies 200 shown in the second exemplary embodiment. The priority order determination unit 76, for example, may receive a setting by the user from the wireless communication terminal 1 as shown in FIG. 14, to determine the priority order based on the received setting. The priority order determination unit 76 gives notification of the created list 100 to the wireless communication terminal 1 via the communication unit 70.

The processing rule determination unit 71 generates a processing rule to be set in the virtual switch 14, based on a wireless access scheme selected by the RAT selection unit 74 by referring to the network management DB 75.

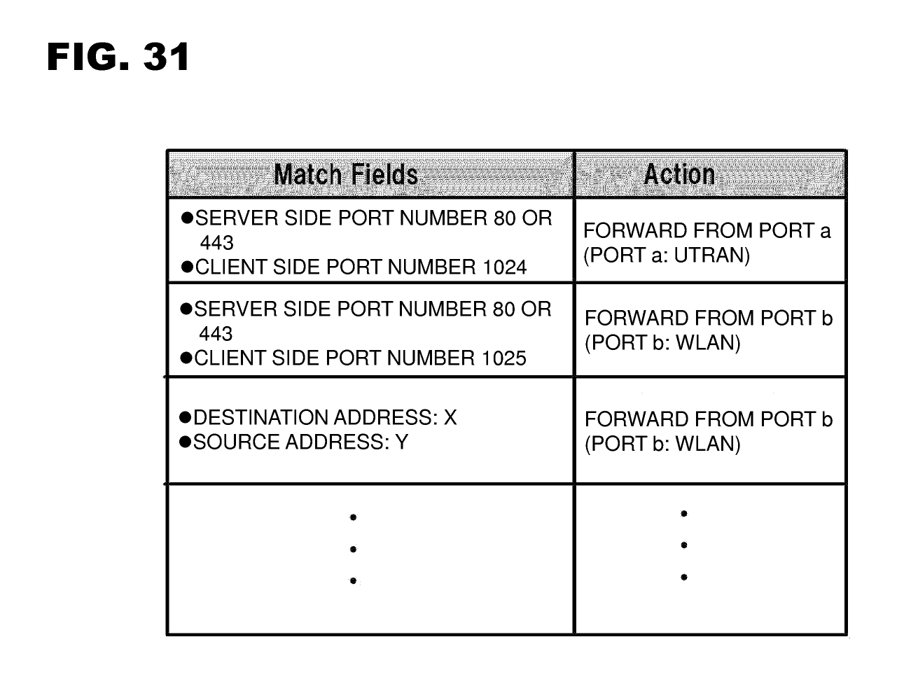

FIG. 31 shows an example of the processing rule. The processing rule, for example, corresponds to a flow entry of OpenFlow. Each row in a table in FIG. 31 is a processing rule.

“Match Field” is a condition for distinguishing a flow. For example, a condition for distinguishing a flow according to a port number of a communication or a condition for distinguishing a flow based on information (destination address, transmission source address, or the like) included in a packet, is set in “Match Field.” In the example of FIG. 31, a condition of “destination address is X and transmission source address is Y” is set in “Match Field.” In the example of FIG. 31, a condition based on a client side port number and a server side port number is set in “Match Field.”

“Action” is a processing method for a packet belonging to a flow matching the condition of “Match Field.” In the example of FIG. 31, an operation that forwards a packet from a switch port 140 of the virtual switch 14 is set in an “Action” field.

The terminal management unit 73 manages correspondence relationships between communication interfaces 10 of the wireless communication terminal 1 and switch ports 140 corresponding to the respective interfaces. The terminal management unit 73, for example, recognizes correspondence relationships between the communication interfaces 10 and the switch ports 140 according to a report from the wireless communication terminal 1. The terminal management unit 73 manages the correspondence relationships between the communication interfaces 10 and the switch ports 140, for each identifier (for example, IMSI (International Mobile Subscriber Identity) or the like) of the wireless communication terminal 1.

Communication equipment (network switches and the like) conforming to OpenFlow has a function (Port Status) to give notification of the status of a port of the communication equipment to a controller, and a function (Feature Request/Reply) to notify a switch characteristic to the controller. The terminal management unit 73 may manage correspondence relationships between the communication interfaces 10 and the switch ports 140 of the virtual switch 14, based on information notified by these functions.

The processing rule determination unit 71, for example, generates a processing rule corresponding to each wireless access scheme selected by the RAT selection unit 74. For example, in a case where the RAT selection unit 74 selects “3G” and “WiFi” as wireless access schemes, the processing rule determination unit 71 generates a processing rule corresponding to each of “3G” and “WiFi.”

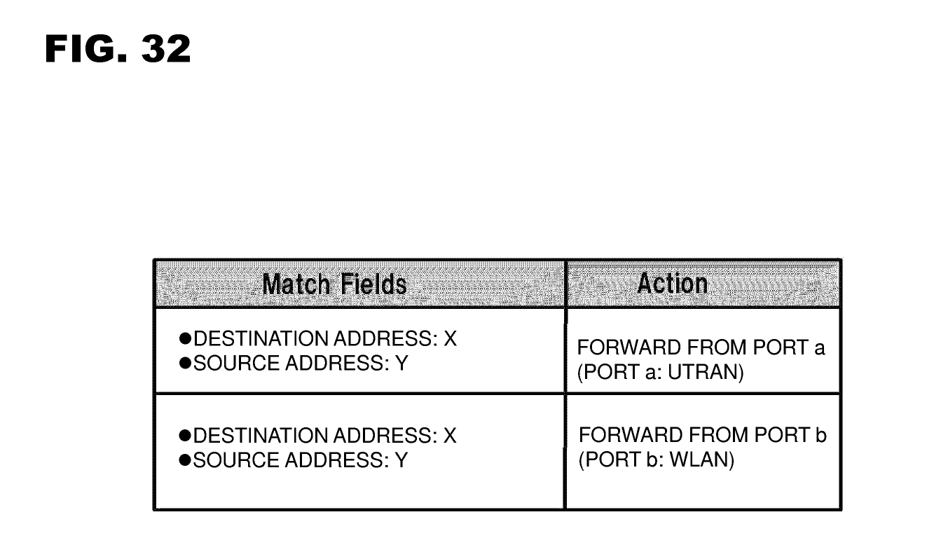

FIG. 32 shows an example of the processing rule generated by the processing rule determination unit 71. In the example of FIG. 32, two processing rules are generated by the processing rule determination unit 71. The processing rule determination unit 71, for example, sets an identical condition in each “Match Field” of processing rules corresponding to each wireless access scheme selected by the RAT selection unit 74. The processing rule determination unit 71 refers to the terminal management unit 73 to retrieve a switch port 140 corresponding to the wireless access scheme selected by the RAT selection unit 74. The processing rule determination unit 71 sets an instruction to forward a packet to the retrieved switch port 140, in a processing rule “Action.” In the example of FIG. 32, the processing rule determination unit 71 sets in the “Action” field a process of forwarding a packet to a port corresponding to the “3G” wireless access scheme, in the processing rule of the first line. The processing rule determination unit 71 sets in the “Action” field a process of forwarding a packet to a port corresponding to the “WiFi” wireless access scheme, in the processing rule of the second line.

The processing rule determination unit 71 contains the determined processing rule in the management DB 72. The processing rule determination unit 71 notifies the virtual switch 14 of the determined processing rule via the communication unit 70.

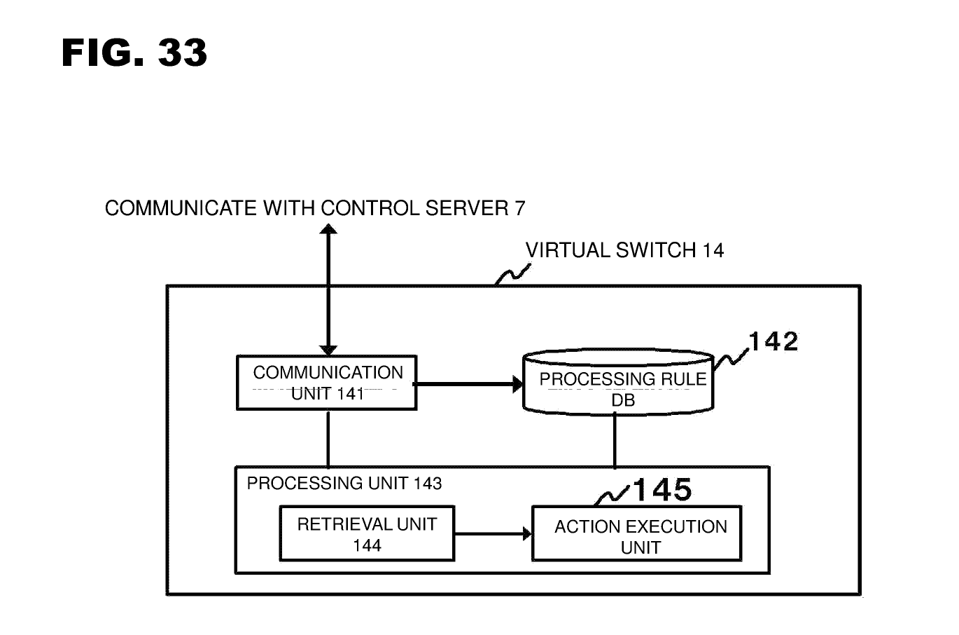

FIG. 33 shows an example of a configuration of the virtual switch 14.

A communication unit 141 communicates with the control server 7 in accordance with the OpenFlow protocol.

A processing unit 143 processes a packet in accordance with a processing rule notified by the control server 7.

A retrieval unit 144 retrieves a processing rule corresponding to a received packet, from the processing rule DB 142. The retrieval unit 144 matches a packet and a “Matching Field” of a processing rule stored in the processing DB 142, to retrieve a processing rule corresponding to the packet. An action execution unit 145 processes a packet in accordance with a processing method defined in the “Action” field of the retrieved processing rule.

In a case where a processing rule corresponding to the received packet is not present in the processing rule DB 142, for example, the retrieval unit 144 requests setting of a processing rule to the control server 7.

The control unit 11 displays the list 100 communicated by the control server 7 on a display-apparatus. The control unit 11 detects a wireless access scheme selected from the displayed list 100 by the user. The control unit 11 sets, in the processing rule DB 142, a processing rule corresponding to the wireless access scheme selected by the user, among a plurality of processing rules (for example, the processing rules shown in FIG. 32) transmitted from the control server 7. For example, in a case where wireless access schemes included in the list 100 are “3G” and “WiFi,” and the user selects “3G,” the control unit 11 sets, in the processing rule DB 142, a processing rule of the first line corresponding to “3G,” among two processing rules shown in FIG. 32. Therefore, the processing unit 143 can execute a process in accordance with a processing rule corresponding to the wireless access scheme selected from the list 100 by the user.

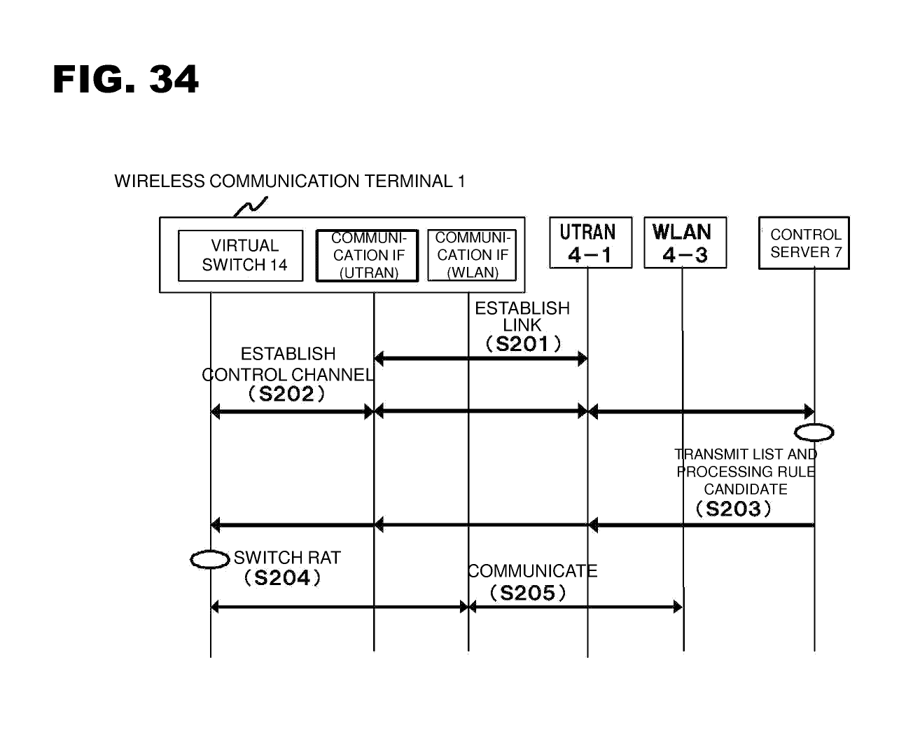

FIG. 34 is a sequence diagram showing an operational example of the sixth exemplary embodiment.

The wireless communication terminal 1 establishes a link with a prescribed RAT (for example, UTRAN 4-1) (step S201). The wireless communication terminal 1, for example, establishes a link with the prescribed RAT when an operation is started (for example, when a power supply is turned on, or the like). The wireless communication terminal 1 establishes a link with the prescribed RAT by a corresponding communication interface 10. The prescribed RAT, for example, is a communication line of a communications operator with which the wireless communication terminal 1 has a contract.

The wireless communication terminal 1 sets a control channel to the control server 7, via a RAT in which a link is established (step S202). The wireless communication terminal 1 communicates with the control server 7 via the control channel. The control channel, for example, is a secure channel 701 in OpenFlow technology as described above.

The control server 7 transmits the list 100 and processing rules corresponding to the respective wireless access schemes included in the list 100, to the wireless communication terminal 1 (step S203).

The wireless communication terminal 1 sets a processing rule corresponding to the wireless access scheme selected by the user from the list 100, in the virtual switch 14. The virtual switch 14 switches wireless access scheme (RAT) in accordance with the set processing rule (step S204).

The wireless communication terminal 1 communicates via the switched wireless access scheme (RAT) (step S205).

### Seventh Exemplary Embodiment

A seventh exemplary embodiment illustrates an example using an ANDSF (Access Network Discovery and Selection Function). The ANDSF relates to technology promoting standardization in the 3GPP (3rd Generation Partnership Project). The ANDSF relates to technology for giving notification of information for selecting a wireless access scheme (RAT) to a terminal. In the seventh exemplary embodiment, a function for giving notification of information for selecting a wireless access scheme to a terminal is improved to be utilized in the present invention.

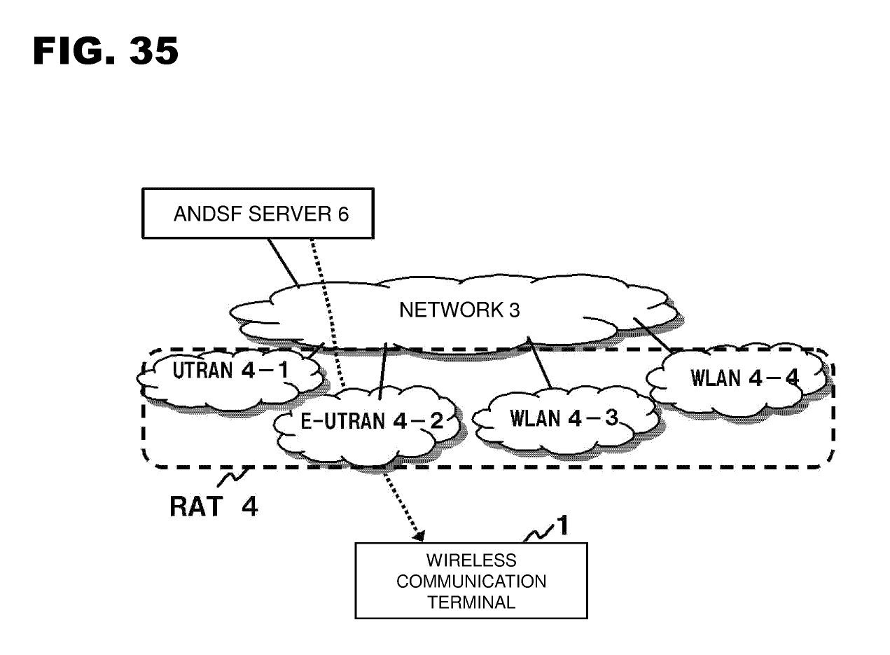

FIG. 35 shows an example of a system configuration of the seventh exemplary embodiment. It is to be noted that the seventh exemplary embodiment can be applied to any of the exemplary embodiments described above.

An ANDSF server 6, for example, determines the priority order of a wireless access scheme by a method shown in the second exemplary embodiment. The ANDSF server 6 notifies a wireless communication terminal 1 of a list 100 in accordance with the determined priority order.

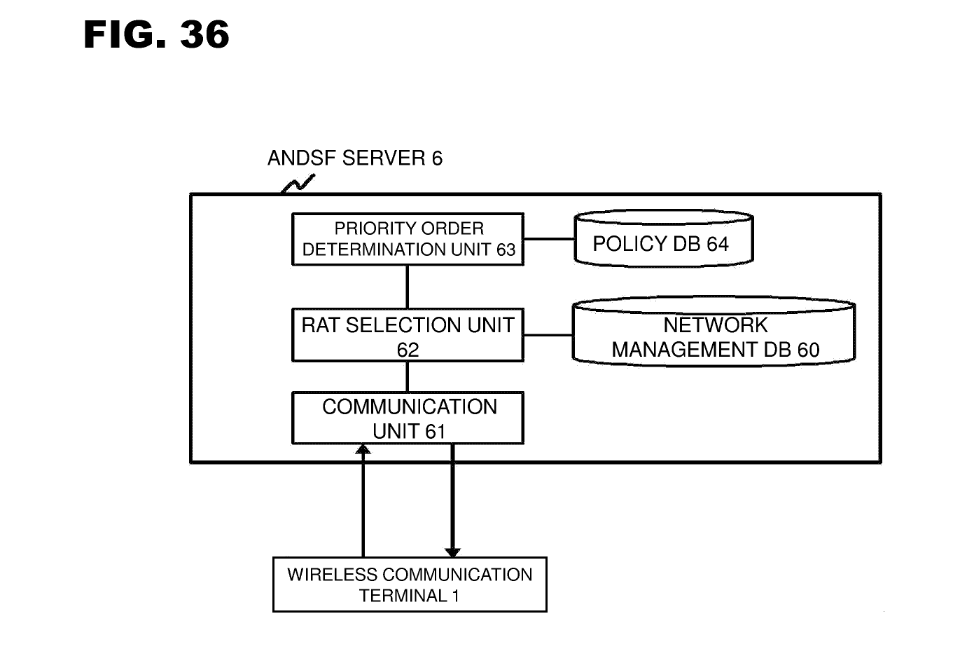

FIG. 36 shows an example of a configuration of the ANDSF server 6.

The ANDSF server 6 includes a network management DB 60, a communication unit 61, a RAT selection unit 62, a priority order determination unit 63, and a policy DB 64. The network management DB 60, the RAT selection unit 62, the priority order determination unit 63, and the policy DB 64 have functionality similar to the exemplary embodiments described above (for example, FIG. 25 in the fifth exemplary embodiment).

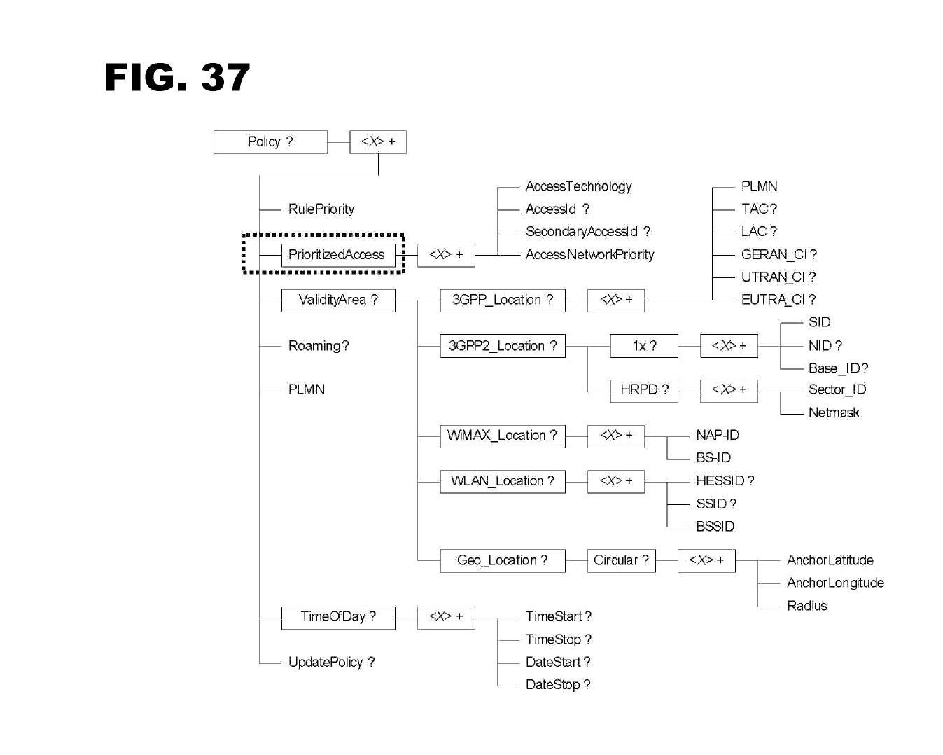

The ANDSF server 6, for example, gives notification of information to the wireless communication terminal 1 by a Management Object (MO), as shown in FIG. 37. The ANDSF server 6 gives notification of the management object to the wireless communication terminal 1, via the communication unit 61.

A management object is configured by a tree type structure as shown in the example of FIG. 37. The management object structure is specified by a standards specification (3GPP TS24.312). FIG. 37 shows some parameters used in a display of the list 100 of wireless access schemes, among the management objects.

In FIG. 37, a parameter “Prioritized Access” is enclosed by a Dotted Line. The priority order determination unit 63 sets a parameter “Prioritized Access,” based, for example, on a priority order determined by a method shown in the second exemplary embodiment. The ANDSF server 6 gives notification to the wireless communication terminal 1 of a management object including “Prioritized Access” set as a parameter by the priority order determination unit 63.

The control unit 11 of the wireless communication terminal 1, for example, refers to the notified management object “Prioritized Access” to generate the list 100. The control unit 11 displays the generated list 100 in a display-apparatus, and recommends switching of wireless access scheme to the user.

<Eighth Exemplary Embodiment>

In an eighth exemplary embodiment, in a case where a communication interface corresponding to a wireless access scheme selected from a list 100 by a user is stopped, a wireless communication terminal 1 starts up a communication interface.

Power consumption of the wireless communication terminal 1 increases as the number of running communication interfaces increases. Accordingly, a user of the wireless communication terminal 1 may stop some of the communication interfaces (for example, an interface corresponding to a WLAN). In the eighth exemplary embodiment, since a communication interface corresponding to a wireless access scheme selected by the user is automatically started up, user convenience is improved while curtailing the power consumption of the wireless communication terminal 1.

The eighth exemplary embodiment can be applied to any of the exemplary embodiments described above.

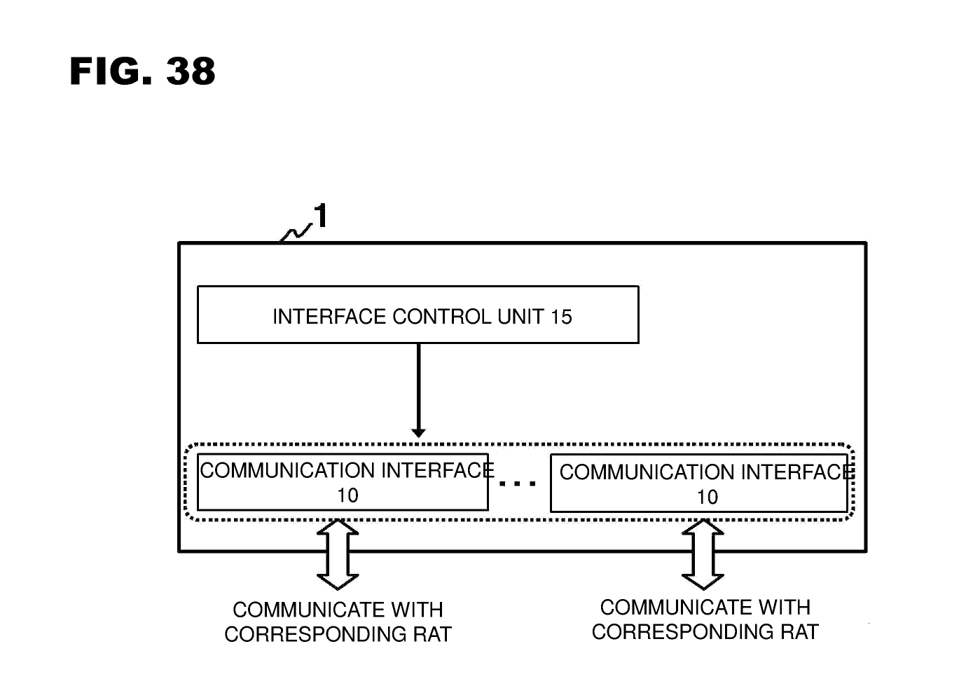

FIG. 38 shows an example of a configuration of the wireless communication terminal 1 of the eighth exemplary embodiment.

The wireless communication terminal 1 has an interface control unit 15 added to the configuration example of the exemplary embodiments described above.

In a case where a communication interface corresponding to a wireless access scheme selected by a user is stopped, the interface control unit 15 starts the relevant communication interface. The interface control unit 15, for example, starts up the communication interface 10 by changing an operation setting that is “Off” or “Inactive” to “On” or “Active.” A communication interface 10 with an operation setting of “Off” stops a prescribed operation such as monitoring of radio wave state. By the operation setting going to “On,” the communication interface 10 is started up. By the operation setting going to “On,” the communication interface 10 can communicate with a RAT.

The interface control unit 15 may stop operation of an interface not in use when a communication interface 10, which was selected according to communication charge, is started up. In this way, it is possible to further reduce power consumption of the wireless communication terminal 1.

### Ninth Exemplary Embodiment

In a ninth exemplary embodiment, a wireless communication terminal 1 downloads an application having a function corresponding to a control unit 11 and a communication unit 12, from a distribution server 8.

The ninth exemplary embodiment can be applied to any of the exemplary embodiments described above.

According to the ninth exemplary embodiment, even in a case where the wireless communication terminal 1 does not have a function corresponding to the control unit 11 and the communication unit 12, a user of the wireless communication terminal 1 can use the present invention by downloading the application.

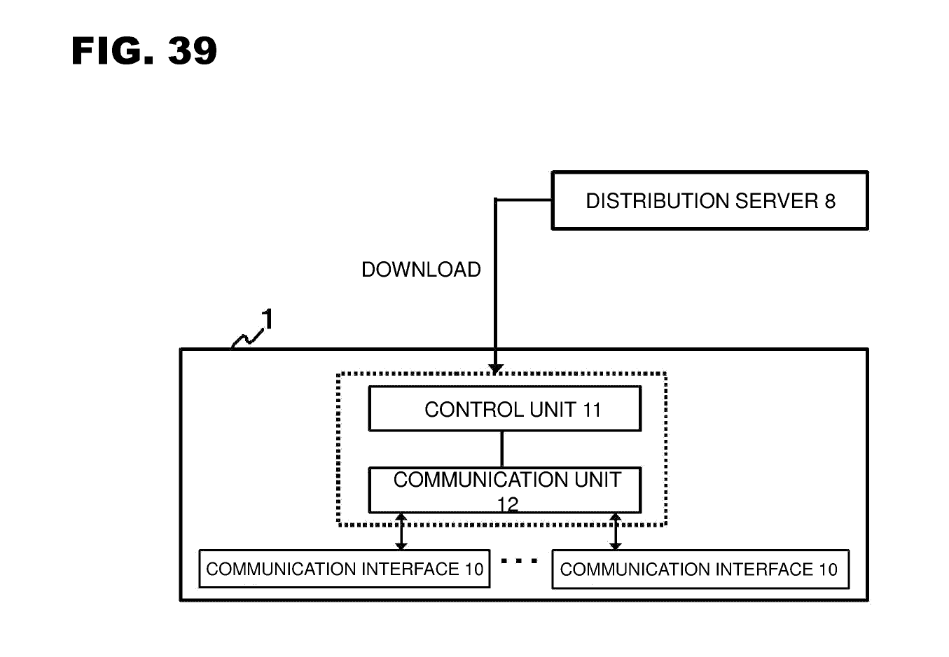

FIG. 39 shows an example of a system configuration of the ninth exemplary embodiment.

The wireless communication terminal 1 downloads the application that has a function corresponding to the control unit 11 and the communication unit 12, from the distribution server 8.

The entire disclosures of the above Patent Literatures are incorporated herein by reference thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

### REFERENCE SIGNS LIST

1 wireless communication terminal
10 communication interface
11 control unit
100 list
101 application
102 communication state icon
103 web browser
104 link
110 priority order determination unit
111 display unit
112 RAT determination unit
12 communication unit
120 switch port
13 application
14 virtual switch
15 interface control unit
140 switch port
141 communication unit
142 processing rule DB
143 processing unit
144 retrieval unit
145 action execution unit
200 policy
201 setting screen
202 switch
203 input box
3 network
4 RAT
40 base station
5 control server
50 network management DB
51 communication unit
52 RAT selection unit
53 priority order determination unit
6 ANDSF server
60 network management DB
61 communication unit
62 RAT selection unit
63 priority order determination unit
7 control server
70 communication unit
71 processing rule determination unit
72 management DB
73 terminal management unit
74 RAT selection unit
75 network management DB
76 priority order determination unit
77 policy DB
8 distribution server
600 OpenFlow switch
601 flow table
700 OpenFlow controller
701 secure channel

What is claimed is:

1. A wireless communication terminal, comprising:
a plurality of communication interfaces each of which corresponds to at least one of a plurality of wireless access schemes;
a first unit for displaying information representing the plurality of wireless access schemes as a list in accordance with a priority order; and
a second unit for communicating using a communication interface corresponding to a wireless access scheme selected from the list.

2. The wireless communication terminal according to claim 1, wherein
the first unit displays the list in response to a change in status related to the wireless communication terminal.

3. The wireless communication terminal according to claim 1, wherein
the first unit displays the list in response to a status change accompanying movement of the wireless communication terminal.

4. The wireless communication terminal according to claim 1, wherein
the first unit displays the list in response to a status change accompanying a communication operation of the wireless communication terminal.

5. The wireless communication terminal according to claim 1, wherein
the first unit displays the list in response to a prescribed operation.

6. The wireless communication terminal according to claim 1, wherein
the first unit displays the list in response to an operation related to execution of communication.

7. The wireless communication terminal according to claim 1, wherein
the first unit displays the list in response to selection of an application for performing communication.

8. The wireless communication terminal according to claim 1, wherein
the first unit displays a list including information forming a reference for the priority order.

9. The wireless communication terminal according to claim 1, wherein
the first unit displays the list based on a display condition that can be set by a user of the wireless communication terminal.

10. The wireless communication terminal according to claim 1, comprising:
a third unit for modifying a setting of a communication interface corresponding to a wireless access scheme selected from the list so that the communication interface is available.

11. The wireless communication terminal according to claim 1, wherein
the first unit stops display of the list in a case where a priority order of a wireless access scheme in which a connection is established is not less than a prescribed rank.

12. The wireless communication terminal according to claim 1, wherein
the first unit receives the list from a control apparatus that controls network access by the wireless communication terminal, and displays the received list.

13. A communication method, comprising:
using a wireless communication terminal that comprises a plurality of communication interfaces corresponding to at least one of a plurality of wireless access schemes;
displaying information representing the plurality of wireless access schemes as a list in accordance with a priority order; and
communicating using a communication interface corresponding to a wireless access scheme selected from the list.

14. The communication method according to claim 13, wherein
the wireless communication terminal displays the list in response to a change in status related to the wireless communication terminal.

15. The communication method according to claim 13, wherein
the wireless communication terminal displays the list in response to a status change accompanying movement of the wireless communication terminal.

16. The communication method according to claim 13, wherein
the wireless communication terminal displays the list in response to a status change accompanying a communication operation of the wireless communication terminal.

17. The communication method according to claim 13, wherein
the wireless communication terminal displays the list in response to a prescribed operation.

18. The communication method according to claim 13, wherein
the wireless communication terminal displays the list in response to an operation related to execution of communication.

19. The communication method according to claim 13, wherein
the wireless communication terminal displays the list in response to selection of an application for performing communication.

20. The communication method according to claim 13, wherein
the wireless communication terminal displays a list including information forming a reference for the priority order.

21. The communication method according to claim 13, wherein
the wireless communication terminal displays the list based on a display condition that can be set by a user of the wireless communication terminal.

22. The communication method according to claim 13, comprising:
by the wireless communication terminal, modifying a setting of a communication interface corresponding to a wireless access scheme selected from the list so that the communication interface is available.

23. The communication method according to claim 13, comprising:
by the wireless communication terminal, stopping display of the list in a case where a priority order of a wireless access scheme in which a connection is established is not less than a prescribed rank.

24. The communication method according to claim 13, comprising:
by the wireless communication terminal, receiving the list from a control apparatus that controls network access by the wireless communication terminal, wherein
the wireless communication terminal displays the received list.

25. A non-transitory computer-readable recording medium storing a program that causes a wireless communication terminal comprising a plurality of communication interfaces corresponding to at least one of a plurality of wireless access schemes to execute:
displaying information representing the plurality of wireless access schemes as a list in accordance with a priority order; and
communicating using a communication interface corresponding to a wireless access scheme selected from the list.

26. An information processing apparatus, comprising:
a first unit for enabling communication with a wireless communication terminal comprising a plurality of communication interfaces corresponding to at least one of a plurality of wireless access schemes; and
a second unit for determining priority order of the plurality of wireless access schemes and transmitting a list in accordance with the priority order to the wireless communication terminal.

27. A distribution server, comprising:
a unit for distributing a program to a wireless communication terminal comprising a plurality of communication interfaces corresponding to at least one of a plurality of wireless access schemes, wherein
the program causes the wireless communication terminal to execute:
displaying information representing the plurality of wireless access schemes as a list in accordance with a priority order; and
communicating using a communication interface corresponding to a wireless access scheme selected from the list.
